(19) United States
(12) Patent Application Publication
(10) Pub. No.: US 2024/0428213 A1
(43) Pub. Date: Dec. 26, 2024

(54) SYSTEM AND METHOD FOR SPLIT BILLING FOR TRANSACTIONS

(71) Applicant: WHIMSTAY, INC., Dover, DE (US)

(72) Inventors: Behshad Jamshahi, Dover, DE (US); Kamesh Jasani, Dover, DE (US); Noël Christina Russell, Emeryville, CA (US)

(21) Appl. No.: 18/670,581

(22) Filed: May 21, 2024

Related U.S. Application Data
(63) Continuation of application No. 17/993,767, filed on Nov. 23, 2022, now abandoned.
(60) Provisional application No. 63/283,065, filed on Nov. 24, 2021.
(60) Provisional application No. 63/305,989, filed on Feb. 2, 2022.

(51) Int. Cl. G06Q 20/10; G06Q 10/02; G06Q 30/0645; G06Q 50/163

(52) U.S. Cl. CPC G06Q 20/102; G06Q 10/02; G06Q 30/0645; G06Q 50/163

(57) ABSTRACT

Disclosed are example embodiments for systems and methods for split rental of a property. The systems and method include identifying a suitable property, determine that the property is suitable for more than one person, and transfer to split booking based on the determination. The systems and method also include receive input of a number of split-bookers, receive input on how to split fees, transmit notification to the split-bookers, receive agreement to split-book from a split-booker, and select a sharing amount based on the received agreement. The systems and method include determine when the total fee is covered, when the total fee is covered, determine that the booking is still available, and complete booking based on the determination that the booking is still available.

### CROSS-REFERENCE TO RELATED APPLICATIONS

The present application is a continuation of U.S. patent application Ser. No. 17/993,767, filed Nov. 23, 2022, which claims priority to U.S. Provisional Patent Application No. 63/283,065, filed Nov. 24, 2021, and U.S. Provisional Patent Application No. 63/305,989, Feb. 2, 2022, all of which are hereby expressly incorporated by reference in their entireties.

### FIELD

The present disclosure relates generally to the field of transaction billing, and more specifically, some embodiments relate to systems and methods for split billing and communication features within a travel system.

### BACKGROUND

An impediment for booking shared vacation rentals by some market demographics is having one “booker” fund the entire transaction and then seek compensation from the 5-6 friends sharing the rental. Often, the fee for reservation may exceed the maximum on a credit card, or the “booker” may feel future collection of money from friends to cover their share is uncomfortable. This is an impediment to book discount travel adventures.

Uber supports fare splitting for ride sharing. When Uber splits a fare, if one of the designated “splitters” does not accept the ride, the booking person pays their share. In the vacation rental space, one person is used to reserve the property. This includes the rental fee, damage deposit, and incidentals. There are no provisions for pre-splitting of the rental deposit.

Therefore, needs exist for systems, devices and methods to allow for splitting of billing that allows for a friend to suggest a rental booking to friends who will share the accommodations and the expense. When these friends subscribe to the booking, the entire transaction may split between all parties.

The feature of “sharing” a property is used widely on the Whimstay travel website or application. The “share” feature creates a link of a property and allows users to copy the link and share outside of the travel Whimstay website or application. It may be assumed that users use the “share” feature on the travel Whimstay website or application to discuss the property to plan the next trip.

Travel websites or other travel applications do not allow users to have group chats within the websites or applications, however. Rather, users of the travel websites or other travel applications have to access external chat applications to discuss potential travel destinations. For example, users may have to talk to people to agree to come on a trip using external chat applications. Accessing an external chat application to discuss potential travel destinations is a hassle. Additionally, accessing an external chat application makes it more difficult to access information that is on the travel websites or other travel applications. Accessing an external chat application to discuss potential travel destinations may also make bill-splitting more difficult as the chat is independent from the booking on the travel websites or other travel applications. Additionally, to share different potential places for the proposed trip within an external chat, users have to copy, and either send within the chat, email, or send over a text message. Additionally, keeping track of people's comments and opinions within the external chat may take a great deal of scrolling to check different statements within the chat or marking different opinions as favorite messages. Final votes on the proposed trip may also take a great deal of coordination and be a cumbersome process. In some cases, a phone call may be required to get a person's final vote. Accordingly, using a travel website with a separate chat application may be a tiresome process and it may be difficult to split up different tasks for planning the trip.

Therefore, needs also exist for a travel website or application to have a built-in chat feature that may allow users direct access to the travel website information within the chat.

### SUMMARY

Disclosed are example embodiments of for systems and methods for split rental of a property. The systems and method include identifying a suitable property, determine that the property is suitable for more than one person, and transfer to split booking based on the determination. The systems and method also include receive input of a number of split-bookers, receive input on how to split fees, transmit notification to the split-bookers, receive agreement to split-book from a split-booker, and select a sharing amount based on the received agreement. The systems and method include determine when the total fee is covered, when the total fee is covered, determine that the booking is still available, and complete booking based on the determination that the booking is still available.

Disclosed are example embodiments of systems and methods for a vacation rental property. The method includes presenting a selected travel destination within a TripChat of a travel site. The method also includes allowing for communications to plan a trip to the selected travel destination within the TripChat of the travel site. Additionally, the method includes storing one or more opinions on the selected travel destination within the TripChat of the travel site. The method includes tracking a vote on the selected travel destination within the TripChat of the travel site.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional features and advantages of the invention will be set forth in the descriptions that follow, and in part will be apparent from the description, or may be learned by practice of the invention. The objectives and other advantages of the invention will be realized and attained by the structure particularly pointed out in the written description, claims and the appended drawings.

### BRIEF DESCRIPTION OF THE DRAWINGS

FIG. 1 illustrates an exemplary device, including device screen, in accordance with the systems and methods described herein.

FIG. 2 illustrates an exemplary device, including another device screen, in accordance with the systems and methods described herein.

FIG. 3 illustrates an exemplary device, including another device screen, in accordance with the systems and methods described herein.

FIG. 4 illustrates an exemplary device, including another device screen, in accordance with the systems and methods described herein.

FIG. 5 is a flowchart of an example method of an overview of split payment flow in accordance with the systems and methods described herein.

FIG. 6 illustrates an exemplary device screen including various possible travel destinations, in accordance with the systems and methods described herein.

FIG. 7 illustrates an exemplary device screen including rentals in a location, in accordance with the systems and methods described herein.

FIG. 8 illustrates an exemplary device screen including information on payment splitting, in accordance with the systems and methods described herein.

FIG. 9 illustrates an exemplary device screen including information on a location for rent, in accordance with the systems and methods described herein.

FIG. 10 illustrates an exemplary device screen for confirming and paying, in accordance with the systems and methods described herein.

FIG. 11 illustrates an exemplary device screen including permission to access contacts for payment splitting, in accordance with the systems and methods described herein.

FIG. 12 illustrates an exemplary device screen including contacts for payment splitting, in accordance with the systems and methods described herein.

FIG. 13 illustrates an exemplary device screen including contacts selected for payment splitting, in accordance with the systems and methods described herein.

FIG. 14 illustrates an exemplary device screen including contacts selected for payment splitting, in accordance with the systems and methods described herein.

FIG. 15 illustrates an exemplary device screen for sending a request for splitting, in accordance with the systems and methods described herein.

FIG. 16 illustrates an exemplary device screen for received text message for payment splitting, in accordance with the systems and methods described herein.

FIG. 17 illustrates an exemplary device screen for being invited to payment split, in accordance with the systems and methods described herein.

FIG. 18 illustrates an exemplary device screen for being invited to payment split, in accordance with the systems and methods described herein.

FIG. 19 illustrates an exemplary device screen for confirming and paying, in accordance with the systems and methods described herein.

FIG. 20 illustrates an exemplary device screen including a group chat, in accordance with the systems and methods described herein.

FIG. 21 illustrates an exemplary device screen for a group chat invitation, in accordance with the systems and methods described herein.

FIG. 22 illustrates an exemplary device screen for a group trip fee split, in accordance with the systems and methods described herein.

FIG. 23 illustrates an exemplary device screen for a group trip fee split, in accordance with the systems and methods described herein.

FIG. 24 illustrates an exemplary device screen for a booking confirmation, in accordance with the systems and methods described herein.

FIG. 25 is a flowchart of an example method of invitee split payment flow in accordance with the systems and methods described herein.

FIG. 26 is a flowchart of an example method of planning a trip with a trip board feature and performing a split payment to book a property among the group members in accordance with the systems and methods described herein.

FIG. 27 is a flowchart of an example method of trip owner or initiator flow for a split payment in accordance with the systems and methods described herein.

FIG. 28 is a diagram of an example of mobile application screen flows in accordance with the systems and methods described herein.

FIG. 29 is a flowchart of an example method for group communication in accordance with the systems and methods described herein.

FIG. 30 is another flowchart of another example method for group communication in accordance with the systems and methods described herein.

FIG. 31 is a series of diagrams of another example of mobile application screens including a home screen, a list of TripChats, and an example chat in accordance with the systems and methods described herein.

FIG. 32 is a series of diagrams of another example of mobile application screens including a home screen, a TripChat start screen, a list of people to potentially chat with in the TripChat, and a TripChat invitation screen in accordance with the systems and methods described herein.

FIG. 33 is a series of diagrams of another example of mobile application screens including a home screen, a TripChat invite screen, an example chat within the TripChat, and a list of members of a TripChat in accordance with the systems and methods described herein.

FIG. 34 is a diagram illustrating an example TripChat website in accordance with the systems and methods described herein.

FIG. 35 is a diagram illustrating an example TripChat website including creating a new TripChat in accordance with the systems and methods described herein.

FIG. 36 is a diagram illustrating an example TripChat website including an invitation to a TripChat in accordance with the systems and methods described herein.

FIG. 37 is a diagram illustrating an example TripChat website including an indication that an invitation to a TripChat has been sent in accordance with the systems and methods described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

### DETAILED DESCRIPTION

The following disclosure describes various embodiments of the present invention and method of use in at least one of its preferred, best mode embodiment, which is further defined in detail in the following description. Those having ordinary skill in the art may be able to make alterations and modifications to what is described herein without departing from its spirit and scope. While this invention is susceptible to different embodiments in different forms, there is shown in the drawings and will herein be described in detail a preferred embodiment of the invention with the understanding that the present disclosure is to be considered as an exemplification of the principles of the invention and is not intended to limit the broad aspect of the invention to the embodiment illustrated. All features, elements, components, functions, and steps described with respect to any embodiment provided herein are intended to be freely combinable and substitutable with those from any other embodiment unless otherwise stated. Therefore, it should be understood that what is illustrated is set forth only for the purposes of example and should not be taken as a limitation on the scope of the present invention.

In the following description and in the figures, like elements are identified with like reference numerals. The use of “e.g.,” “etc.,” and “or” indicates non-exclusive alternatives without limitation, unless otherwise noted. The use of “including” or “includes” means “including, but not limited to,” or “includes, but not limited to,” unless otherwise noted.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” can refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein and in the appended claims, the singular forms “a,” “an,” and “the” include plural referents unless the context clearly dictates otherwise.

In general, terms such as “coupled to,” and “configured for coupling to,” and “secure to,” and “configured for securing to” and “in communication with” (for example, a first component is “coupled to” or “is configured for coupling to” or is “configured for securing to” or is “in communication with” a second component) are used herein to indicate a structural, functional, mechanical, electrical, signal, optical, magnetic, electromagnetic, ionic or fluidic relationship between two or more components or elements. As such, the fact that one component is said to be in communication with a second component is not intended to exclude the possibility that additional components may be present between, and/or operatively associated or engaged with, the first and second components.

Generally, embodiments of the present disclosure include systems and methods for creating customizable and programmable tools. The software tools may allow users to schedule communications, software activities, and tasks for current and/or future.

An embodiment applies to financial transactions associated with vacation rental properties. For example, an embodiment provides for a rental booking process where a shared vacation rental does not exclusively impact one person's credit card. This may be particularly appealing to young adults because many young adults may not have as much money for discretionary spending. Accordingly, an aspect allows for payment splitting prior to booking vacation rentals with friends. An example embodiment may allow for splitting of billing to allow for a friend to suggest a rental booking to other friends who will share the accommodations and the expense. When the friends subscribe to the booking, the entire transaction may be split between all parties.

In an example embodiment using the split billing process, one person (e.g., a traveler) may identify a suitable property for a vacation rental. As part of the booking process on an example application, the traveler may be presented with an option to split the booking when the rental supports multiple travelers. When accepted, the traveler may select suitable “friends” from the traveler's contact list, e.g., on a mobile telephone handset, or invite friends from within an example application. In an example embodiment, when the required number of “friends” agree to the rental, the transaction may be completed with the total bill split equally among the friends.

Additionally, the system may automatically design an expiration period for the rental. In an example embodiment, the transaction is not completed until all “friends” indicate acceptance and have a suitable credit card to validate the split transaction. In another example embodiment, the transaction is not completed until a predetermined number of “friends” indicate acceptance and have a suitable credit card to validate the split transaction. For example, assume a property has sleeping accommodations for up to five couples. In some embodiments, the transaction is not completed until all five couples indicate acceptance and have a suitable credit card to validate the split transaction. In another example embodiment, the transaction is not completed until a predetermined number of couples, e.g., all five, four of the five, three of the five, or some other number indicate acceptance and have a suitable credit card to validate the split transaction. In another example embodiment, the transaction is not completed until a predetermined number of people, or couples indicate acceptance and have a suitable credit card to validate the split transaction. For example, with a five-bedroom property, some combination of singles and couples might stay in the property, such as 3 couples and 2 singles, for example. In such an example, the application might allow some number of bedrooms to remain empty and still complete the transaction. For example, 2 couples and 2 singles, or any other combination, up to and including not splitting the property, depending on selections of the traveler and the potential other people involved. For example, the traveler might still want to take the trip even if none of the invited “friends” decide to go on the trip. Accordingly, the traveler might set the required number of acceptances at zero.

In an example embodiment, notifications to split a friend's rental suggestion may be sent to an application implementing the systems and methods described herein. For example, notifications to split a friend's rental suggestion may be sent to an application implementing the systems and methods described herein via text message, e-mail, messages within the application, or other appropriate methods of communication. The message may contain an Internet link to a website detailing the suggested rental.

In an example embodiment, when the recipient has an account with a service implementing the systems and methods described herein, the message link may take the recipient directly to a view page for the rental. The recipient may then view information on the rental property, the proposed term of the split, and accept or reject the recipient's portion of the expense.

When the recipient does not have an account with a service implementing the systems and methods described herein, the recipient may be taken to a sign-in page for an account with a service implementing the systems and methods described herein where the recipient may register for an account. Once an account is established, the recipient may view information on the rental property, the proposed term of the split, and approve or reject the rental.

In an example embodiment, as the booking splits are being reviewed and accepted or rejected, the application implementing the systems and methods described herein may monitor the rental property's availability. When, during the review process, the application implementing the systems and methods described herein finds the listing is no longer available, the transaction may be cancelled. The initial traveler and any friends agreeing to the split may be notified that the property is no longer available.

In another example embodiment, as the booking splits are being reviewed and accepted or rejected, the application implementing the systems and methods described herein may place a “hold” on the rental property's availability to other patrons. A hold may be a period of time when other patrons are not able to attempt to rent the subject property during the traveler's proposed rental period. For example, when the traveler proposes renting a subject property from May 1 to May 7 of a particular year, a hold may be placed on the property from May 1 to May 7 of the particular year. During the hold, in some embodiments, a property may not be visible to other possible renters that are not friends of the traveler. In other embodiments, the property may be visible to other possible renters that are not friends of the traveler, but the property may not be rentable. For example, any other renters may be shown a message that the subject property is on hold. In some embodiments, other possible renters that are not friends of the traveler may be able to be placed on a waiting list in case the rental, e.g., that has not been booked yet, ends up not being rented. The other possible renters that are not friends of the traveler may be informed when the property is rented, when the property is not rented, when the hold is over, or when other events pretendant events that may be of interest to the other possible renters that are not friends of the traveler.

In some examples, the hold may be limited in time. For example, a hold may be 1 hour, 12 hours, 24 hours, or some other period. In some examples, the hold may be variable. For example, in some embodiments, the longer the time until the rental period is, the longer the hold time allowed may be. As the time until the rental period decreases, the hold time allowed may be decreased. In some embodiments, hold time may be variable between a peak-season and a non-peak season. In some embodiments, hold time may be variable between holidays and non-holidays. Additionally, these may also be combined in various ways. For example, hold time may be variable between a peak-season and a non-peak season and between holidays and non-holidays. In another example, hold time may be variable between a peak-season and a non-peak season and between holidays and non-holidays; and the longer the time until the rental period is, the longer the hold time allowed may be.

In an example embodiment that includes a hold time, when a transaction has not been completed and no one is on the wait list at the end of the hold time, the parties to the possible transaction may be informed that the property is still available even though the hold time has ended. Additionally, in some example embodiments, the parties to the possible transaction, e.g., one or more of the traveler or friends of the traveler may be given the option to extend the hold for some period. In some examples, the hold time may be extended automatically when a transaction has not been completed and no one is on the wait list at the end of the original hold time. In some examples, the hold time may be extended multiple times, e.g., when a transaction has not been completed and no one is on the wait list at the end of the original or a subsequent hold time.

In an example embodiment that does not include a hold time, when, during the review process, the application implementing the systems and methods described herein finds the listing is no longer available, the transaction may be cancelled. The initial traveler and any friends agreeing to the split may be notified that the property is no longer available.

During an example rental process as described herein, the renters who have agreed to split the transaction may be able to view acceptances and rejections of the request. For example, the renters who have agreed to split the transaction may be able to view acceptances and rejections of the request in real time. The amount of time remaining on the request may also be displayed. In some examples, the initial initiator, e.g., the traveler, may cancel the transaction and re-split the transaction to a different set of friends if desired before the transaction completes. In another example embodiment, one or more people may drop from a possible transaction. In some embodiments, even the traveler may drop from a transaction and the remaining proposed renters may be able to continue the transaction.

In an example embodiment, when all friends (e.g., generally including the traveler) have agreed to share the rental costs, the rental site may be re-checked for availability. When the rental property is still available, the funds may be collected. In an example, the funds may be collected from the primary traveler and the shared traveler accounts and the booking may be confirmed.

In another example embodiment, when a subset of all the friends (e.g., generally including the traveler) have agreed to share the rental costs, the rental site may be re-checked for availability. When the rental property is still available, the funds may be collected. In an example, the funds may be collected from the primary traveler and the shared traveler accounts and the booking may be confirmed.

In another example embodiment, when a subset of all the friends (e.g., generally including the traveler) have agreed to share the rental costs, e.g., during the hold period, the funds for the rental property may be collected. In an example, the funds may be collected from the primary traveler and the shared traveler accounts and the booking may be confirmed.

In an example embodiment, at no point in the transaction is the initial traveler billed for the entire rental.

In an example embodiment, the process may support unequal shares, which may be common when one or more couples may be booking. For example, the process may support unequal shares for accommodation differences (e.g., bunk bed versus double bed.) Many different accommodation differences may exist. For example, a “master bedroom” may be more than another type of bedroom. In an example, a bedroom that is only large enough for one person may be less than a bedroom large enough for two people. In another example, a bedroom that is shared with multiple persons may be less, e.g., per person, than a bedroom for one person. In an example, a bedroom that is shared by three or more persons may be less, e.g., per person, than a bedroom for two people. In another example, a bedroom with a view may be more than a bedroom without a view. In an example, these differences in price may be set in the program. In another example, these differences in price may be suggested by the program. In another example, these differences in price may be suggested or proposed by one or more of the various friends, e.g., including or possibly limited to the traveler in some example embodiments.

In an example embodiment, rental verification may be a multi-step process. In proffering the rental, an application implementing the systems and methods described herein may extract “expiring” rentals, e.g., rentals which have open bookings within some predetermined number of days, e.g., the next “N” days). For example, an application implementing the systems and methods described herein may extract “expiring” rentals from sites where the rental property owner has approved the application offering the rental at a discounted rate. In an example, the rental property owner may approve the application offering the rental at a discounted rate in order to move the inventory.

Once the rentals are imported, an application implementing the systems and methods described herein may poll the rental calendars on the core rental sites. When the property books, the rental may be removed. If a split payment is in process, an application implementing the systems and methods described herein may continue to monitor (e.g., poll) the rental calendars at the core sites. Again, when a property books externally (or internally with another customer of the particular application implementing the systems and methods described herein), the split payment offer may be withdrawn, e.g., in an embodiment that does not include holds, when a hold expires with a group on a waiting list, or when a rental from another application or site occurs.

In an example embodiment, once the split payment is confirmed, there may be a final poll of external calendars, e.g., in an implementation without holds. When the rental is still available, the rental may be confirmed. When the rental has booked, notice may be sent to the prospective “split” renters.

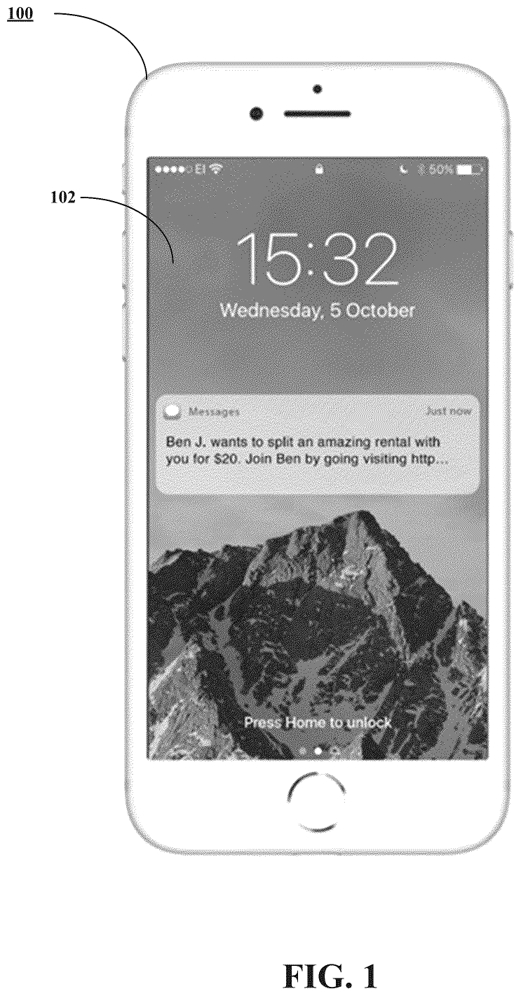

FIG. 1 illustrates an exemplary device 100, including device screen 102, in accordance with the systems and methods described herein. In the example of FIG. 1, a “friend” or possible “split-booker” receives a message informing the “friend” or possible “split-booker” that “Ben J. wants to split an amazing rental with you for $20. Join Ben by going visiting http . . . ” Accordingly, FIG. 1 illustrates an example invitation to split book. It will be understood that other examples are possible.

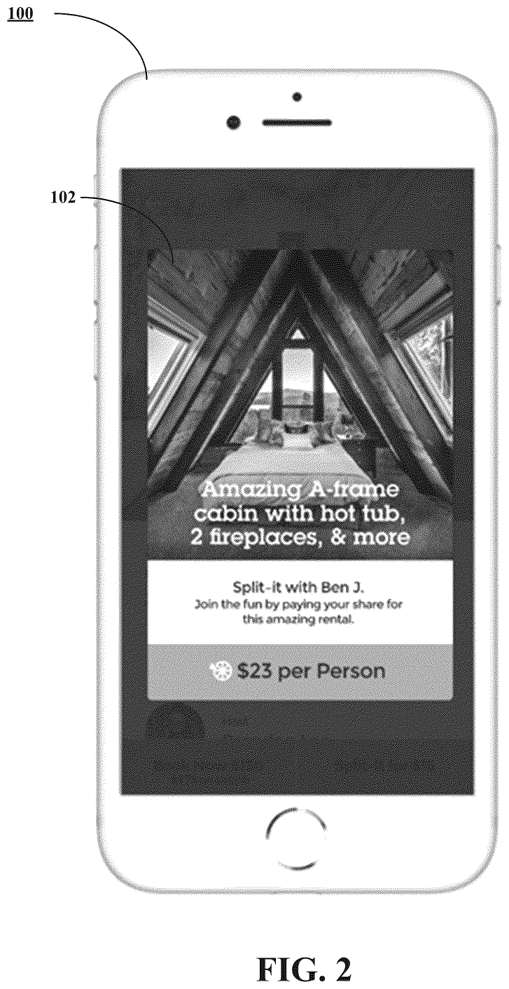

FIG. 2 illustrates an exemplary device 100, including another device screen 102, in accordance with the systems and methods described herein. FIG. 2 illustrates a possible web site for the split booking. For example, the “friend” or possible “split-booker” that received “Ben J's” invitation may access the example web site after receiving the invitation. In an example, a fee for the split booking of $3 may be included, e.g., bringing the total to $23 from the offer at $20. In another example, the price may be dynamic and may change as people agree or disagree to join the trip, cancel, or take other actions that may impact the price per person.

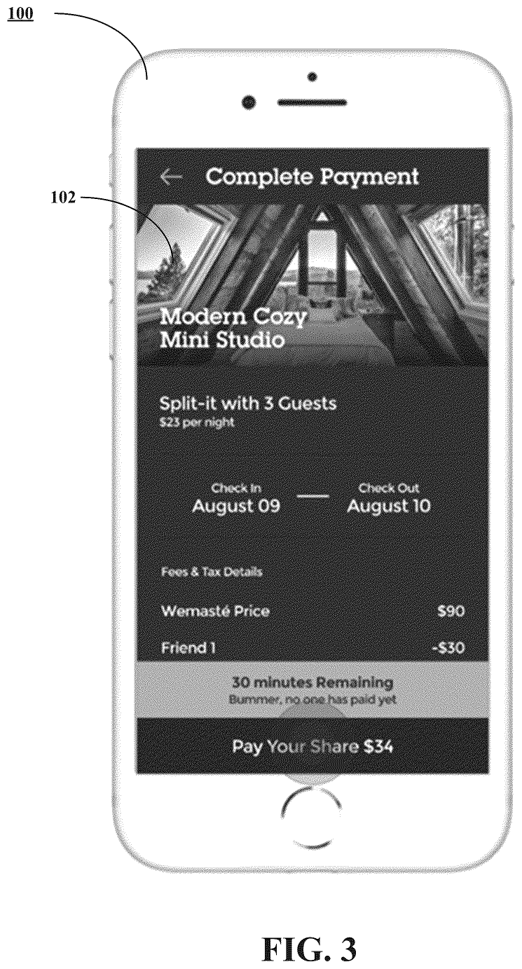

FIG. 3 illustrates an exemplary device 100, including another device screen 102, in accordance with the systems and methods described herein. For example, in FIG. 3 a possible web site showing more details for the split booking is illustrated. For example, the “friend” or possible “split-booker” that received “Ben J's” invitation and accessed the web site illustrated in FIG. 2 may access the example web site of FIG. 3. Additional details of the booking may be shown, such as dates of stay, current cost per night for that person or couple, fees, and tax details, including total costs and costs being covered by other people may be shown. Time remaining to complete the split may also be shown.

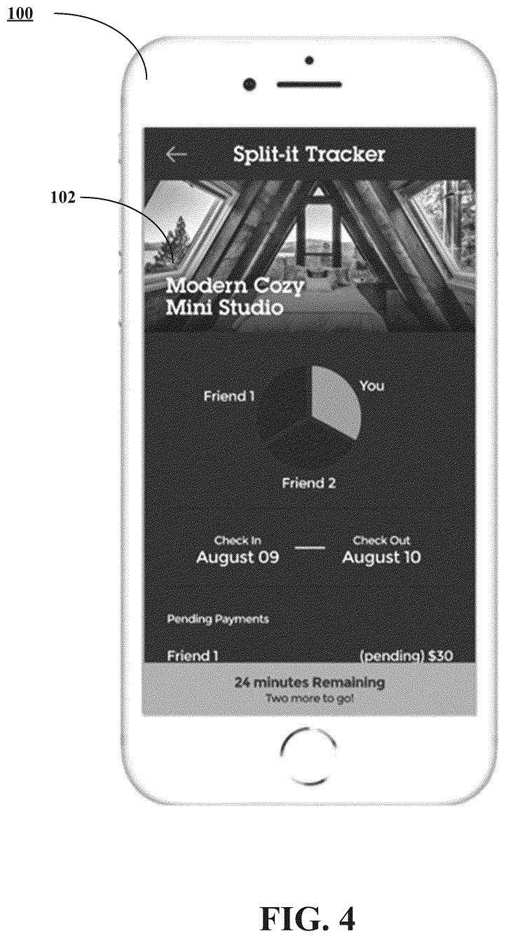

FIG. 4 illustrates an exemplary device 100, including another device screen 102, in accordance with the systems and methods described herein. FIG. 4 illustrates a possible web site showing other details for the split booking. For example, a pie chart showing the split is illustrated in FIG. 4. Additional details of the booking may be shown, such as dates of stay, pending payments, and costs being covered by other people. Time remaining to complete the split may also be shown. It will be understood that FIGS. 1-4 are only examples. Many other possible implementations are also possible.

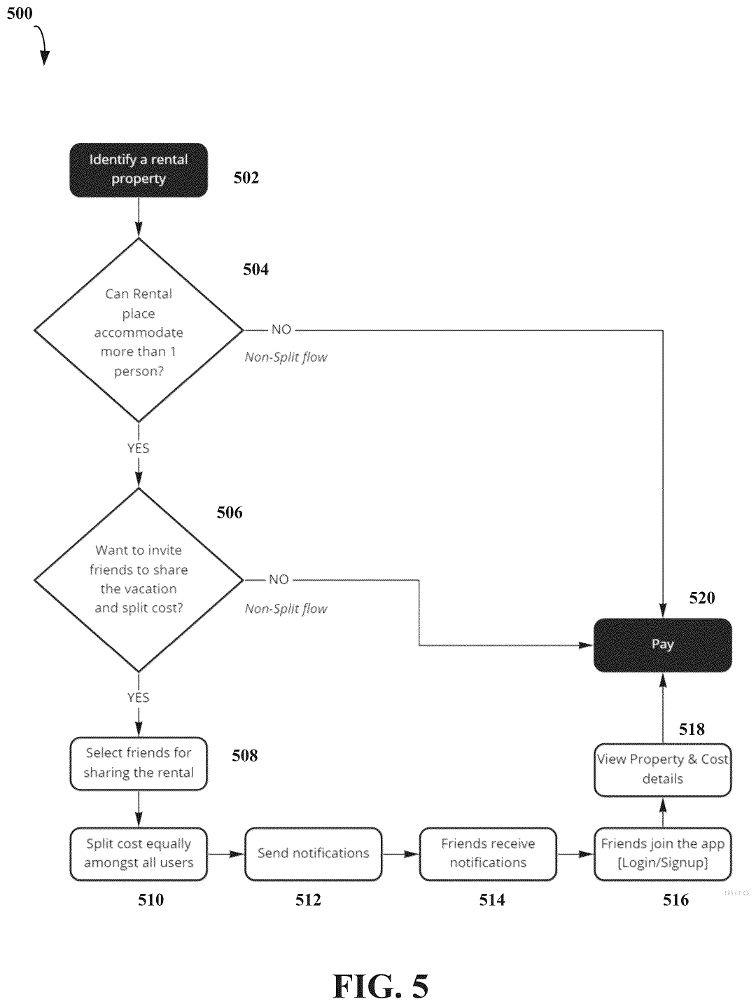

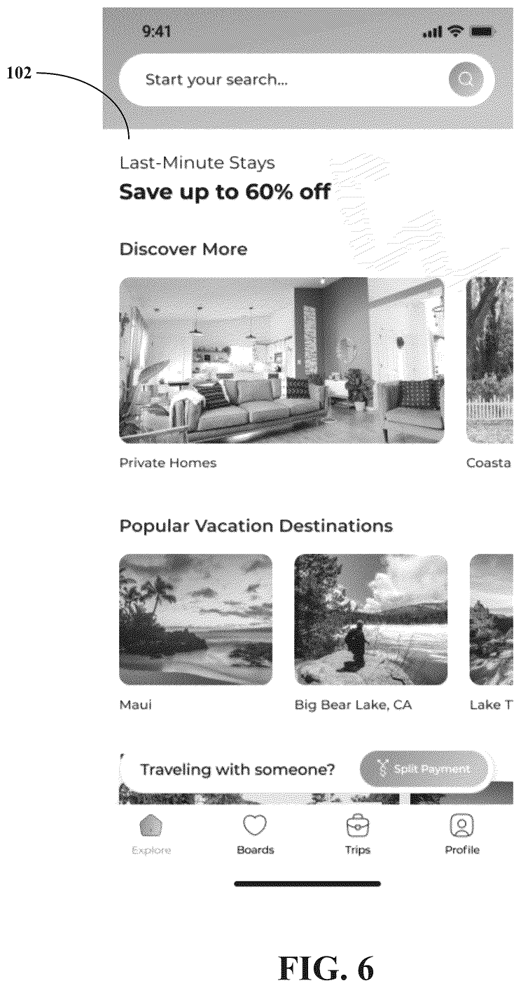

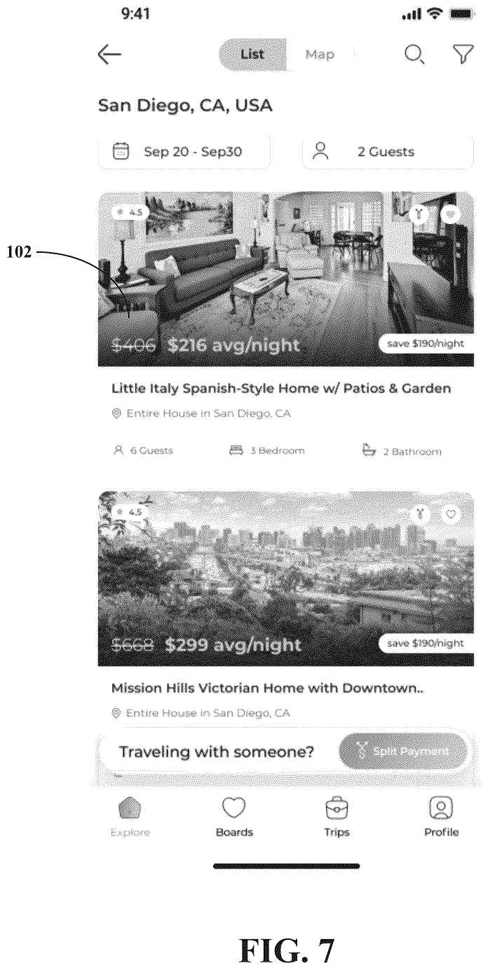

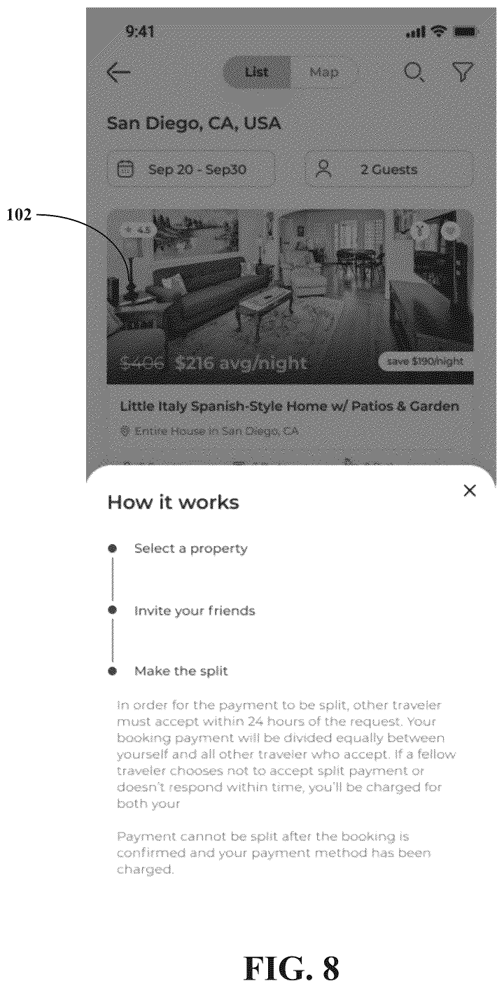

FIG. 5 is a flowchart of an example method 500 in accordance with the systems and methods described herein. In the method illustrated in the flowchart of FIG. 5, a traveler may access a program implementing the systems and methods described herein and identify a suitable vacation rental (502). In the illustrated example method of FIG. 5, the traveler may identify suitable vacation rentals. For example, FIGS. 6-7 illustrate example screens for identifying a property. FIG. 6 illustrates an exemplary device screen 102 including various possible travel destinations, in accordance with the systems and methods described herein. The screen of FIG. 6 includes multiple possible destinations. After a destination is selected, possible rentals at or near that destination may be shown. For example, FIG. 7 illustrates an exemplary device screen 102 including rentals in a location, e.g., San Diego, CA, in accordance with the systems and methods described herein. The systems and methods described herein may provide information on payment splitting. For example, FIG. 8 illustrates an exemplary device screen 102 including information on payment splitting, in accordance with the systems and methods described herein. The screen may include text summarizing payment splitting works, e.g., “How it works.”

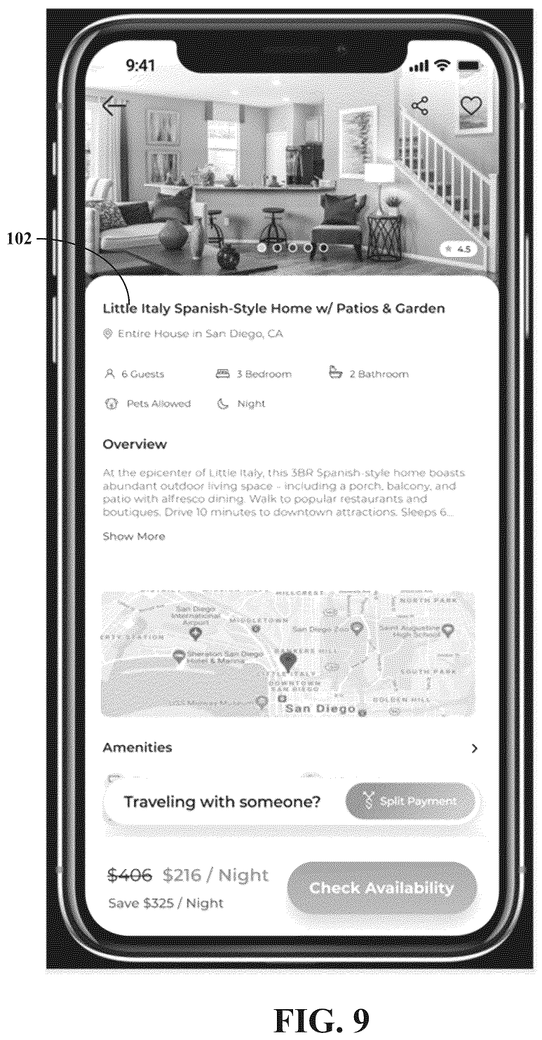

FIG. 9 illustrates an exemplary device screen 102 including information on a location for rent, in accordance with the systems and methods described herein. The location is shown, and various information is provided, such as generally what part of town the rental is in, e.g., “Little Italy,” what type of rental it is, e.g., “Entire House,” the city, e.g., “San Diego,” and other information.

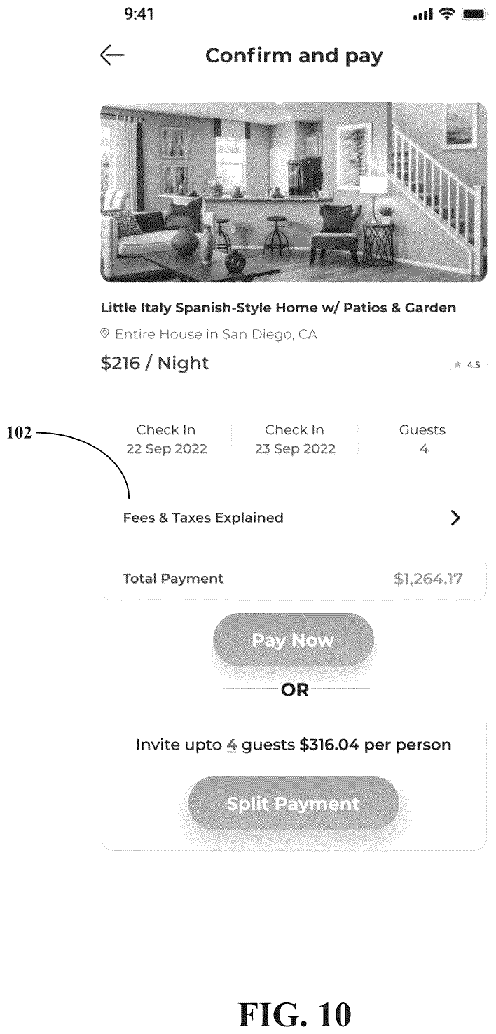

FIG. 10 illustrates an exemplary device screen 102 for confirming and paying, in accordance with the systems and methods described herein. As illustrated, the traveler may “Pay Now” or have the option to “Split Payment.” In the illustrated example, the payment may be split up to four (4) ways.

The vacation rental may accommodate more than one person (or more than one couple, more than one family, or another group of people that would typically rent a property as one unit. When the vacation rental accommodates more than one person the vacation rental may be appropriate to split book (504). When the vacation rental does not accommodate more than one person (or more than one couple, more than one family, or another group) the vacation rental may not be split booked. Accordingly, when the vacation rental does not accommodate more than one person (or more than one couple, more than one family, or another group) the system may proceed to requesting a payment (520), e.g., without split booking.

Determining if the vacation rental sleeps more than one person may be based on one or more of a number of factors. For example, an owner may set a limit on the number of people that may stay in the property. For example, the owner may say that only one individual may stay at the property. At another property, the owner may say that multiple people may stay in the property, e.g., two or more people. In another example, the number of people that may stay in the property may be based on the number of bedrooms, or the size of the bedrooms or some combination of the number and size of the bedrooms. In yet another example the number of people that may stay in the property may be based on the number and size of the beds in the bedrooms in the property. For example, a twin bed may be considered to sleep one person whereas a full-size bed, queen size bed, or king size bed may be considered to sleep two people. Some examples may consider number of couches, Murphy beds, sofa beds, or any number of other possible sleeping accommodations. These factors may be determined from the description of the property, may be provided by the owner, may be provided by property records or from any other suitable source that may be used to determine some aspect of the property that may be used to determine how many people are allowed to rent the property or should consider renting the property.

When it is determined that a property sleeps more than one person the traveler may be offered split booking. For example, the systems and methods described herein may ask a user, e.g., the traveler, if the user wants to invite friends to share the vacation and split costs, e.g., split book the vacation rental (506). When split booking is offered, if the traveler does not want to use the split booking the system may proceed to requesting a payment (520), e.g., without split booking. When split booking is offered, if the traveler desires to use the split booking, some number of friends may be selected as being suitable for sharing the rental (508). This information may be entered by the traveler. For example, in some embodiments the traveler may select friends from an address book on a mobile telephone handset.

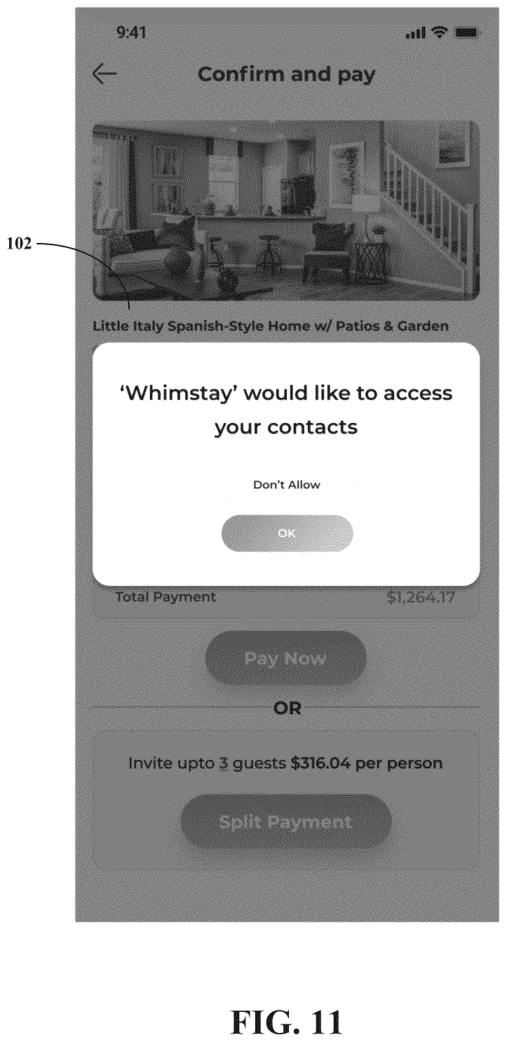

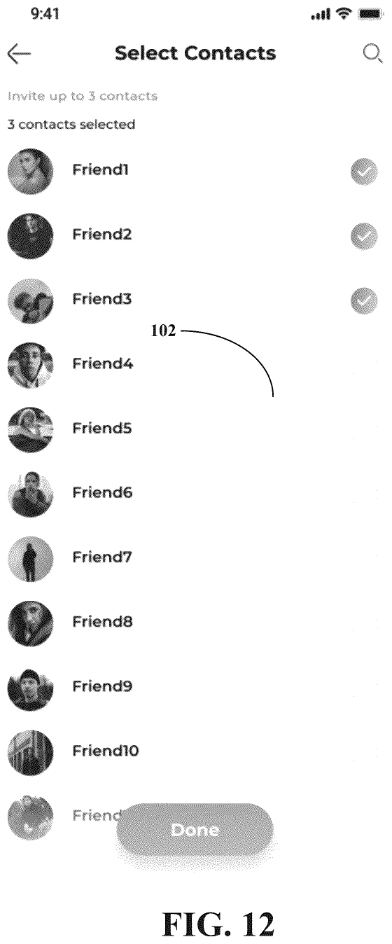

For example, FIG. 11 illustrates an exemplary device screen 102 including permission to access contacts for payment splitting, in accordance with the systems and methods described herein. The contacts may be used to generate invites for the split booking. FIG. 12 illustrates an exemplary device screen 102 including contacts for payment splitting, in accordance with the systems and methods described herein. The screen illustrates examples of friend's being invited to split book, e.g., three friends so far.

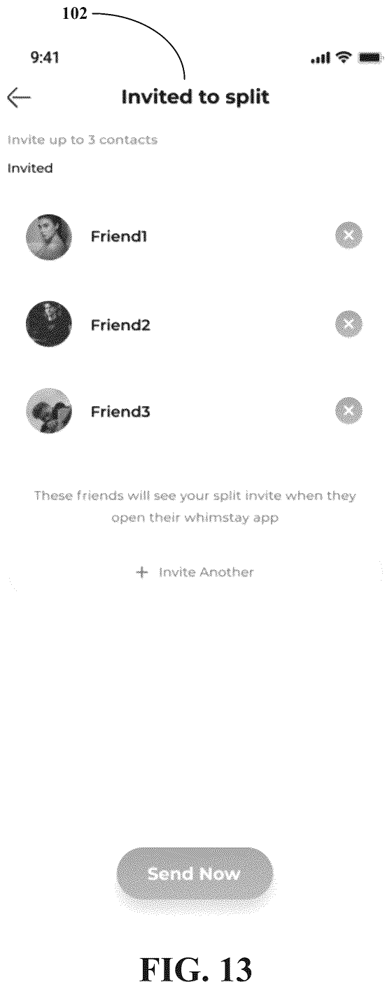

FIG. 13 illustrates an exemplary device screen 102 including contacts selected for payment splitting, in accordance with the systems and methods described herein. The screen illustrates an example with three friends invited to split book. For example, the property may be split up to four ways. Accordingly, the traveler and three friends may book the trip.

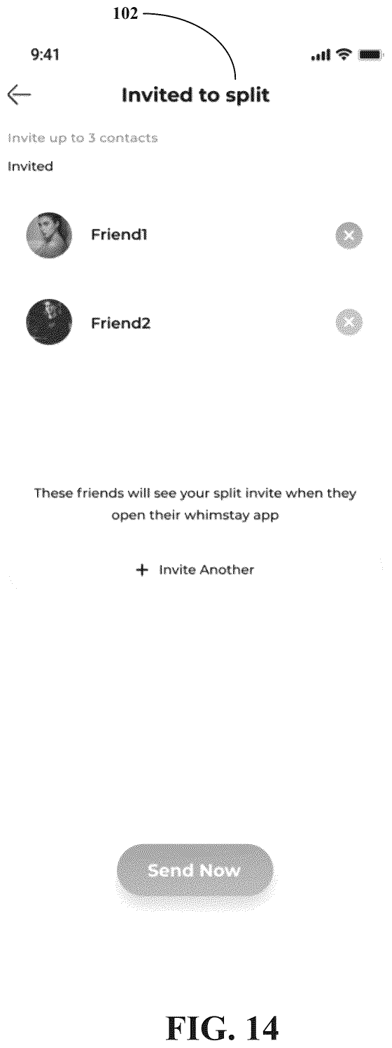

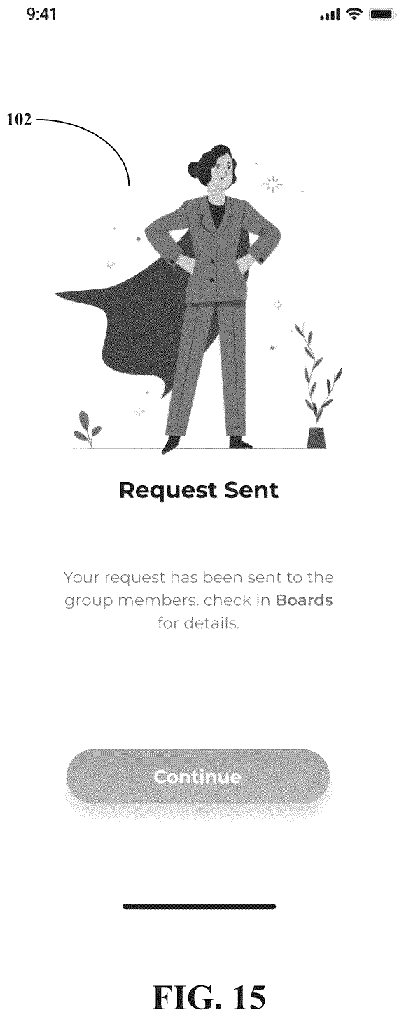

FIG. 14 illustrates an exemplary device screen 102 including contacts selected for payment splitting, in accordance with the systems and methods described herein. The screen illustrates an example of how to send the invitations. FIG. 15 illustrates an exemplary device screen 102 for sending a request for splitting, in accordance with the systems and methods described herein. FIG. 15 illustrates a screen confirming that the invitation was send.

Additionally, in some embodiments the traveler may enter information on how the split should be generated. For example, in some examples, the costs may be split equally (510). In some examples, the traveler may enter information on how the fee should be split between the different people invited on the trip. For example, the split may not always be even in some examples.

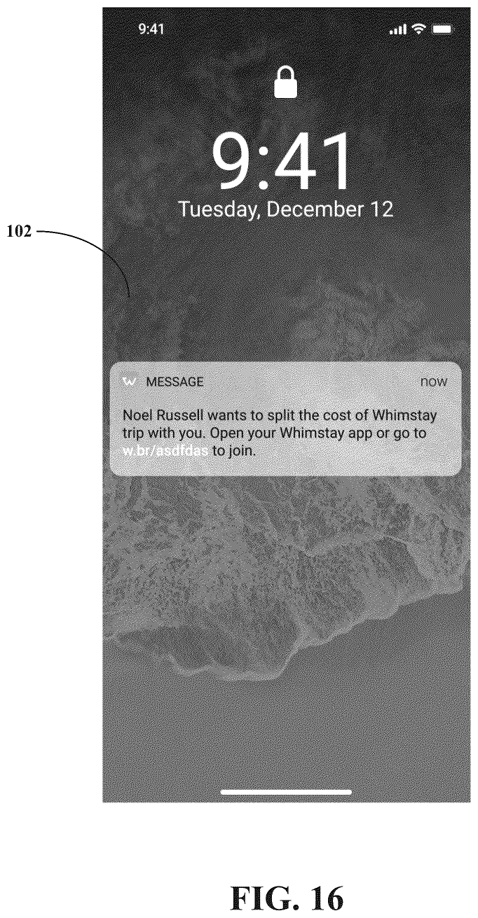

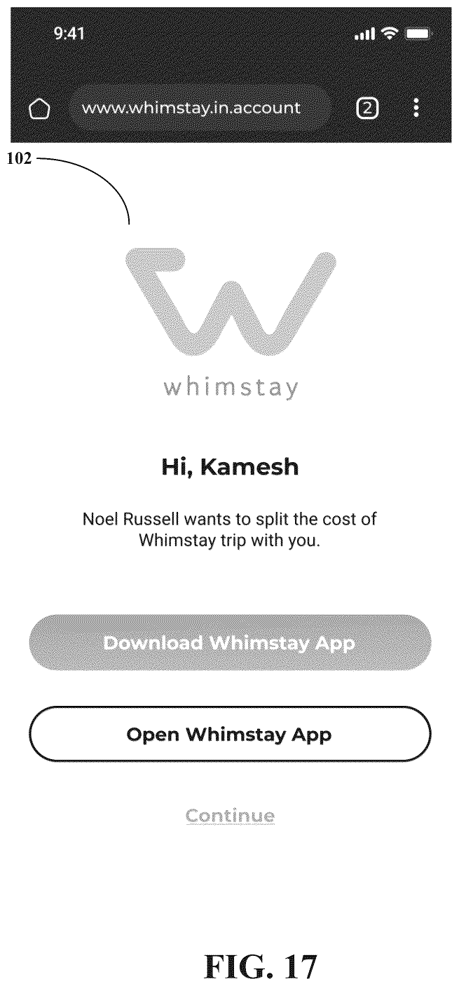

A notification of the proposed split may be sent to the friends that are being invited (512). FIG. 16 illustrates an exemplary device screen 102 for received text message for payment splitting, in accordance with the systems and methods described herein. The friends selected for the trip may receive a notification of the proposed trip and splitting arrangement (514). For example, an email, a text message, or message within the application may be transmitted to the friends. A text message is used in the illustrated example of FIG. 16. The text message may provide a link to a web page for the invitation to the proposed trip. For example, FIG. 17 illustrates an exemplary device screen 102 for being invited to payment split, in accordance with the systems and methods described herein.

In an example embodiment, more friends than the available number of spots may be invited. The first friends to agree to join may get the spots. This may improve the chances that all of the spots are filled.

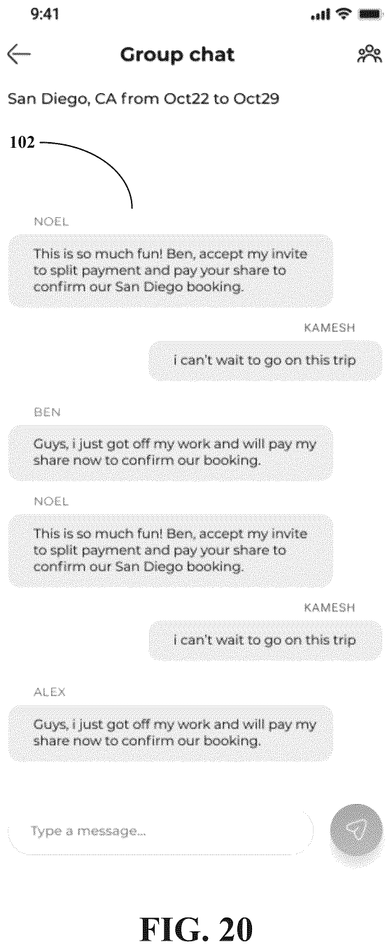

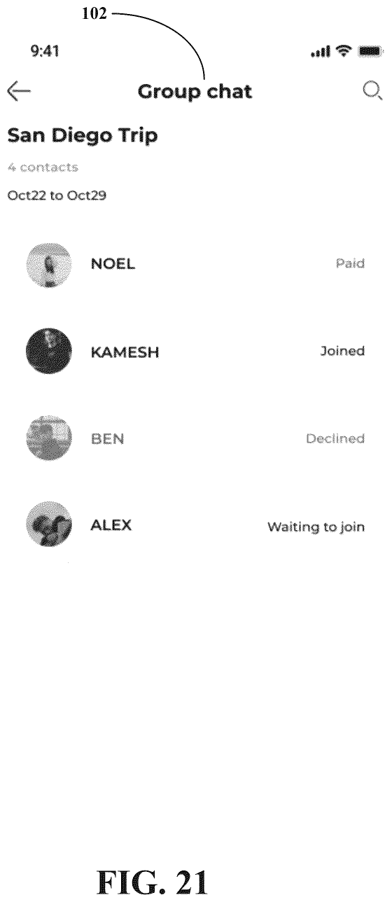

One or more of the friends may agree to share the expenses of the trip and to go on the proposed trip. For example, within a chat within the application, over text messages, by email, or other means of communication. As discussed above, in some examples 100% of the friends invited need to accept for the booking to occur. However, it will be understood that in other embodiments some subset of the friends invited may agree to the trip and the trip may then be booked. FIG. 20 illustrates an exemplary device screen 102 including a group chat, in accordance with the systems and methods described herein. The group chat may be used to discuss the possible rental, for example. FIG. 21 illustrates an exemplary device screen 102 for entering a group chat invitation, in accordance with the systems and methods described herein. Friends invited to split the booking may also be invited to the group chat, for example.

In the illustrated example of FIG. 5, the friends may join the application, e.g., login or sign up (516). Accordingly, the friends may view the property and the cost details. Cost details may include details in variable splitting arrangements. For example, a range of costs may be provided for having different numbers of friends agree to join the trip. Costs may vary based on number of friends joining, couples or singles joining, or other factors. Friends that agree to join the trip may pay their share of the trip's costs (520).

Aspects of some embodiments may include trip splitting. Other aspects of some embodiments may include chat functions that may be used to communicate to set up the trip. Aspects may also include the steps performed by an example embodiment to set up the trip.

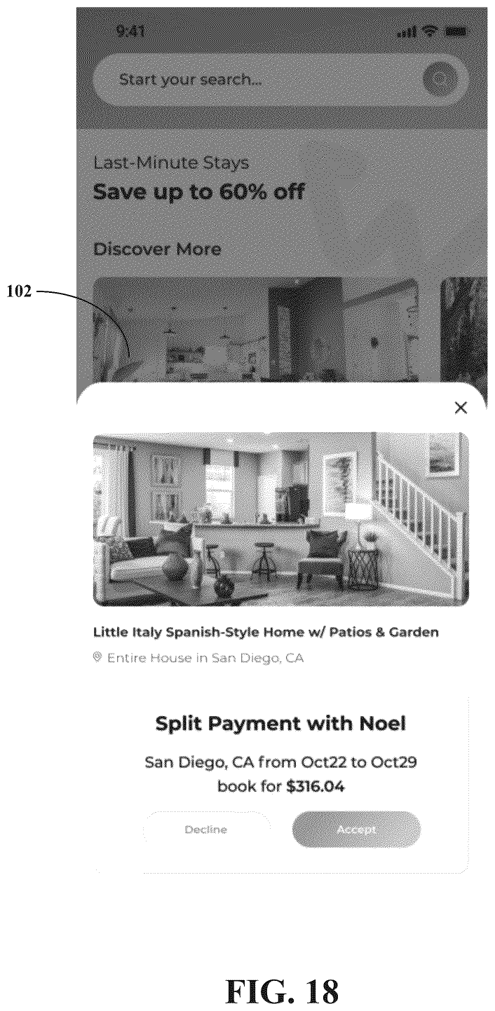

FIG. 18 illustrates an exemplary device screen 102 for being invited to payment split, in accordance with the systems and methods described herein.

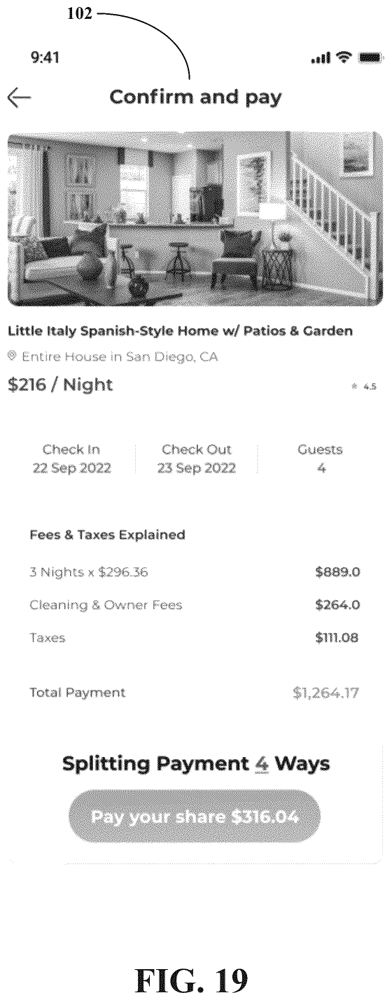

FIG. 19 illustrates an exemplary device screen 102 for confirming and paying, in accordance with the systems and methods described herein. A similar screen may be generated on each of the mobile telephone handsets, or other device, for each person entering into the payment split. The screen may request their share of the payment split. The screen may summarize the fees, the total payment, split information, etc.

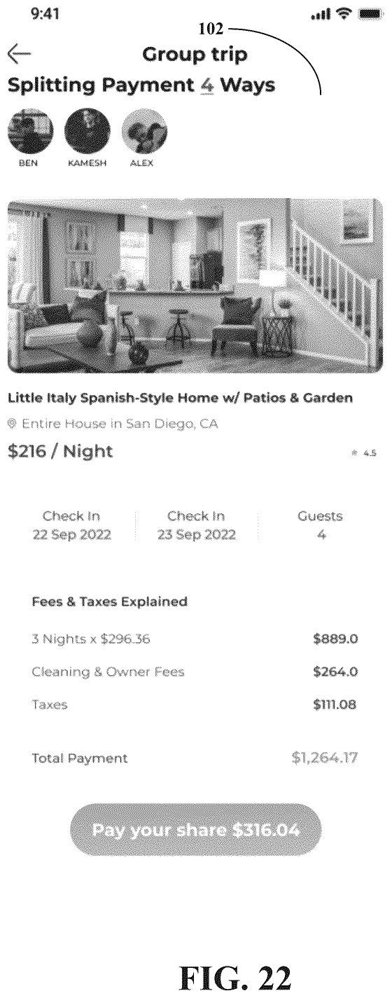

FIG. 22 illustrates an exemplary device screen 102 for a group trip fee split, in accordance with the systems and methods described herein. A similar screen may be generated on each of the mobile telephone handsets, or other device, for each person entering into the payment split. The screen may request their share of the payment split. The screen may summarize the fees, the total payment, split information, etc. The screen may show the other people that are splitting the payment.

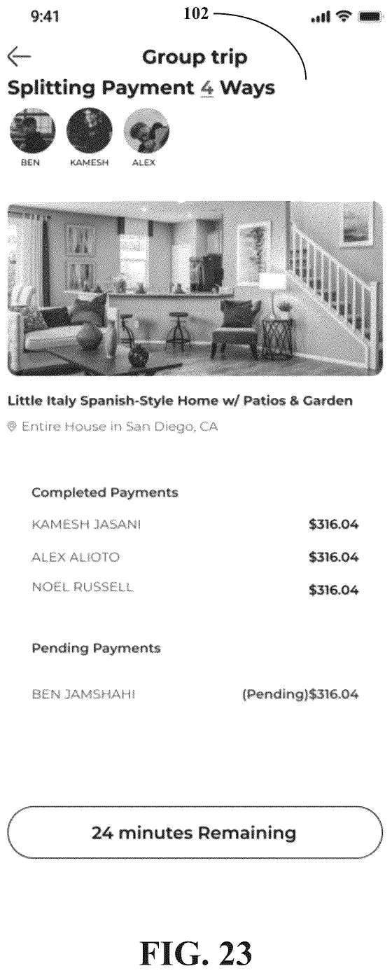

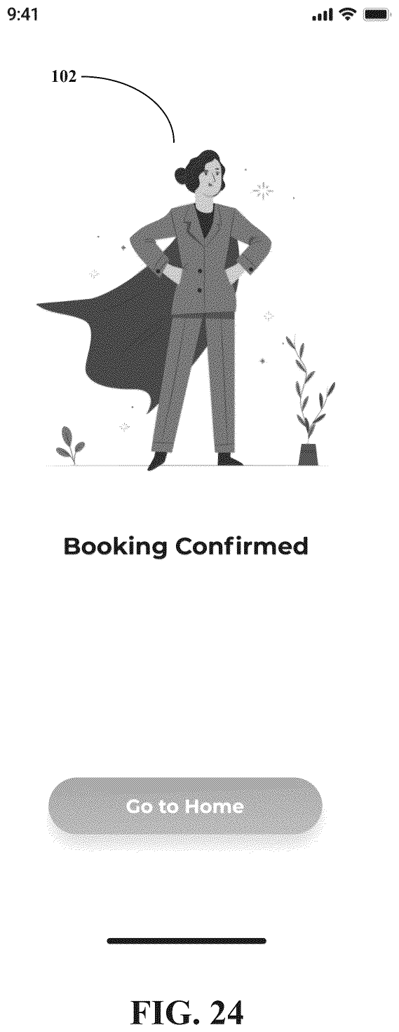

FIG. 23 illustrates an exemplary device screen 102 for a group trip fee split, in accordance with the systems and methods described herein. The example of FIG. 23 illustrates pending and completed payments. FIG. 24 illustrates an exemplary device screen 102 for a booking confirmation, in accordance with the systems and methods described herein.

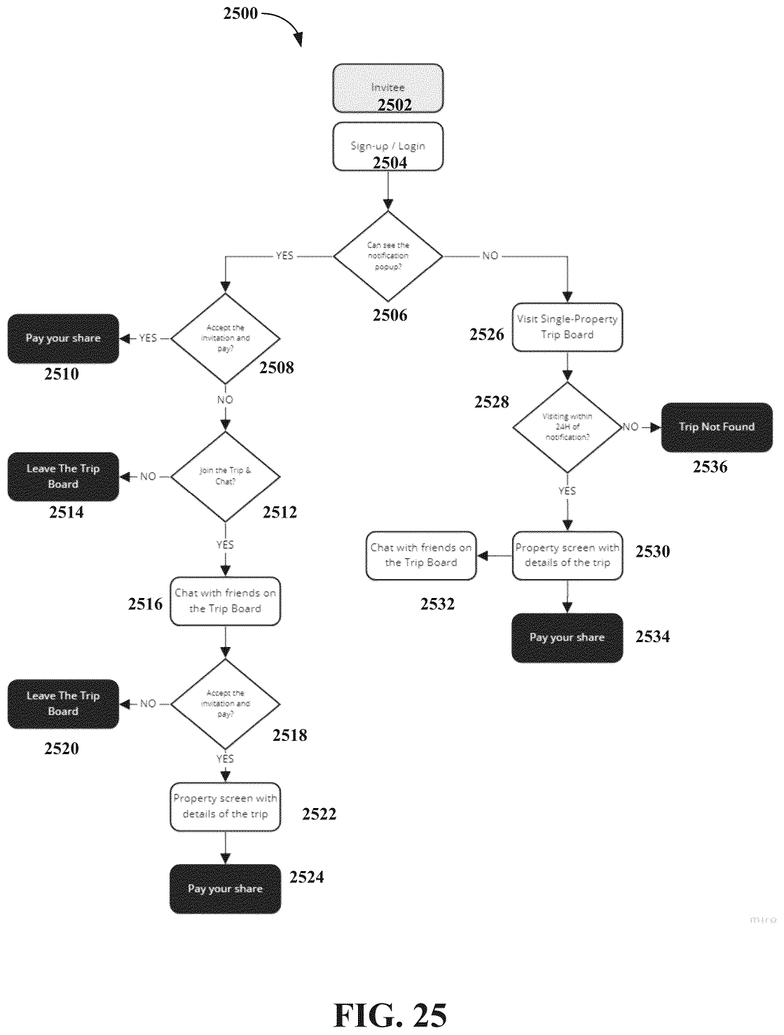

FIG. 25 is a flowchart of an example method 2500 of invitee split payment flow in accordance with the systems and methods described herein. In the illustrated example of FIG. 25 an invitee 2502 may sign up or login 2504 depending on whether they need to establish an account or already have an account, respectively. After signing up and/or logging in, a determination may be made if the invitee can see the notification popup 2506. When the invitee can see the notification popup, the invitee has the opportunity to accept the invitation 2508 and pay for their share 2510. Alternatively, the invitee may either select to join the trip and chat 2512 or may leave the trip board 2514. When the invitee joins the trip and chats 2516, the invitee may determine if they want to go on the trip, for example based on information received in the chat. After chatting with friends on the trip board the invitee may accept the invitation 2518 and pay or leave the trip board 2520 if they do not wish to go on the trip. For example, when the invitee chooses to go on the trip, they may receive additional property screen details of the trip 2522 and then pay their share 2524.

If the invitee cannot see the notification popup, the invitee may visit the single property trip board 2526. If the visit is within some other predetermined timeframe from the notification 2528, e.g., within 24 hours of the notification in the illustrated example, then the property screen with the details of the trip may be available 2530. The invitee may also have the opportunity to chat with friends on the trip board 2532. Finally, the invitee may pay their share of the trip 2534. However, if visiting the single property trip board is not within the predetermined timeframe, e.g., 24 hours, the trip may no longer be available and may not be found 2536.

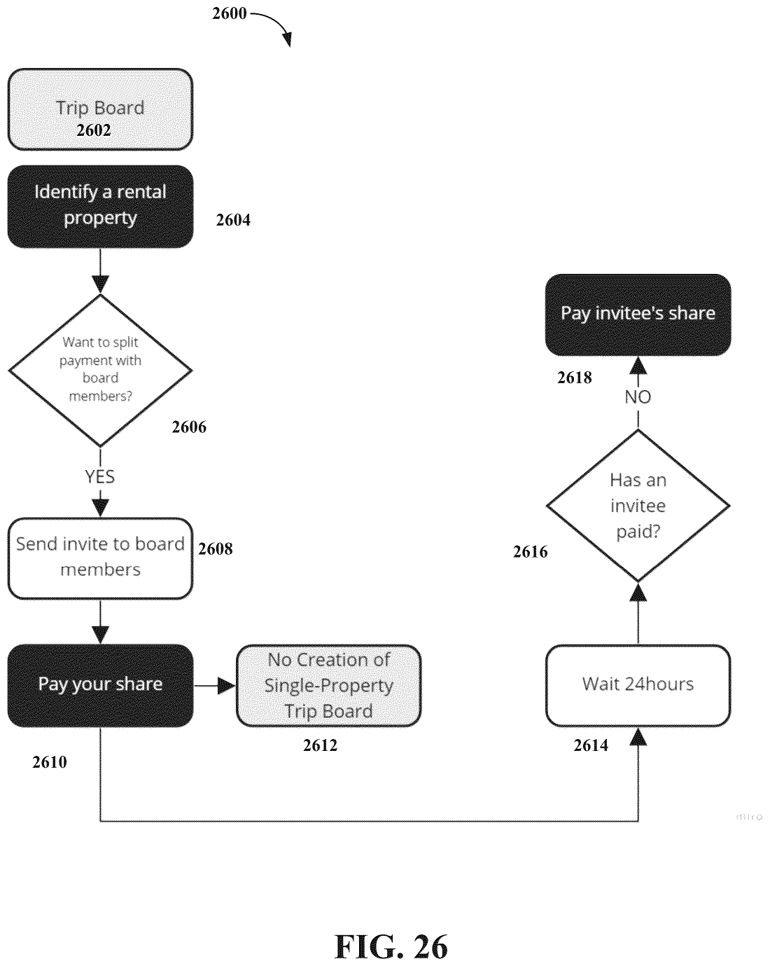

FIG. 26 is a flowchart of an example method 2600 of planning a trip with a trip board feature 2602 and performing a split payment to book a property among the group members in accordance with the systems and methods described herein. FIG. 26 illustrates an example flow on a trip board. Initially a property for rental may be identified 2604. The property may be suitable for split payments. Accordingly, the system may make a determination about whether the user wants to split payments with board members 2606. When a user wants to split payments with board members an invite to the trip may be sent to the board members 2608. Based on the invite the board members may pay for a share of the trip 2610. In some examples, no creation of a single property trip board is performed 2612. Splitting the trip may allow for a waiting period 2614 of some predetermined time period, e.g., 24 hours. After the pre-determined waiting period, the systems and methods described herein may determine if an invitee has paid 2616. When an invitee has not paid the initiator may be requested to pay for that invitee's share 2618. When multiple invitees have not paid, multiple shares may need to be paid to keep the reservation open.

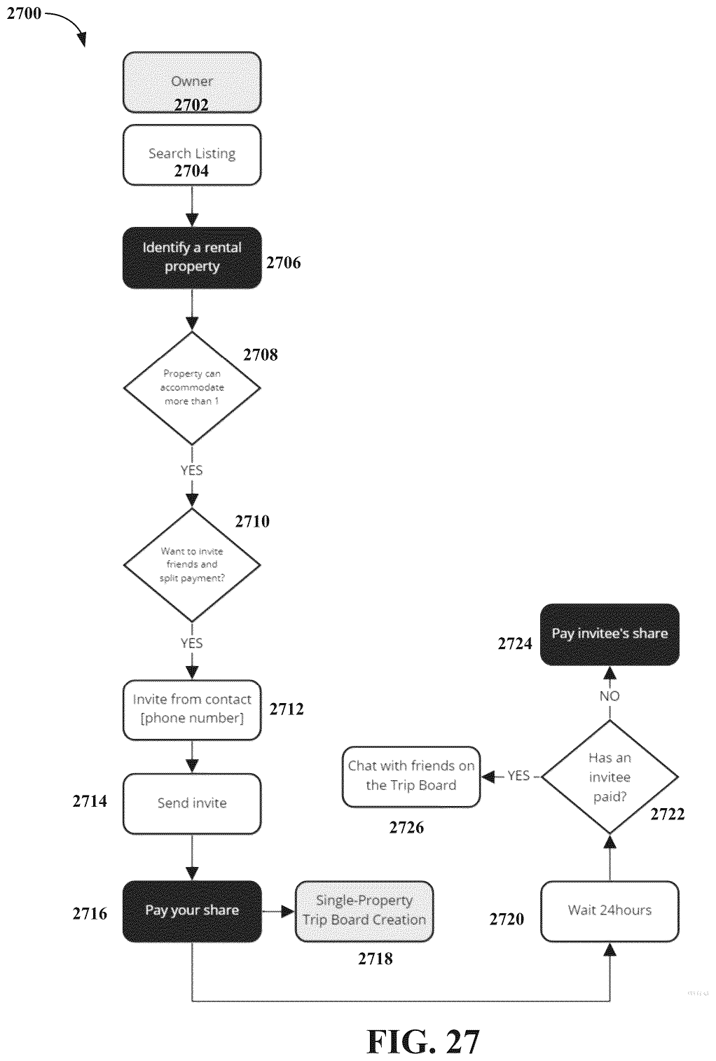

FIG. 27 is a flowchart of an example method 2700 of trip owner 2702 or initiator flow for a split payment in accordance with the systems and methods described herein. As illustrated in the example flow, an owner may search for a listing 2704 and identify a rental property 2706 when the property can accommodate more than one-person 2708, more than one couple, more than one family, or some other unit of people. A determination may be made if split booking or split payments are desired 2710. A number of people may be invited from a contacts list 2712, e.g., using a phone number, an email, text communication, or other communications. Accordingly, an invite can be sent to a friend 2714. After the invite is sent, the invited friend may pay for their share 2716 and a single property trip board may be created 2718. The sharing of the property may be available for some predetermined period 2720, such as 24 hours. After the pre-determined period, e.g., 24 hours, a determination may be made as to whether an invitee has paid 2722. When an invitee has paid 2724, a chat 2726 may be initiated with friends on the trip board. Alternatively, the trip initiator may pay the invitees share to keep the reservation active.

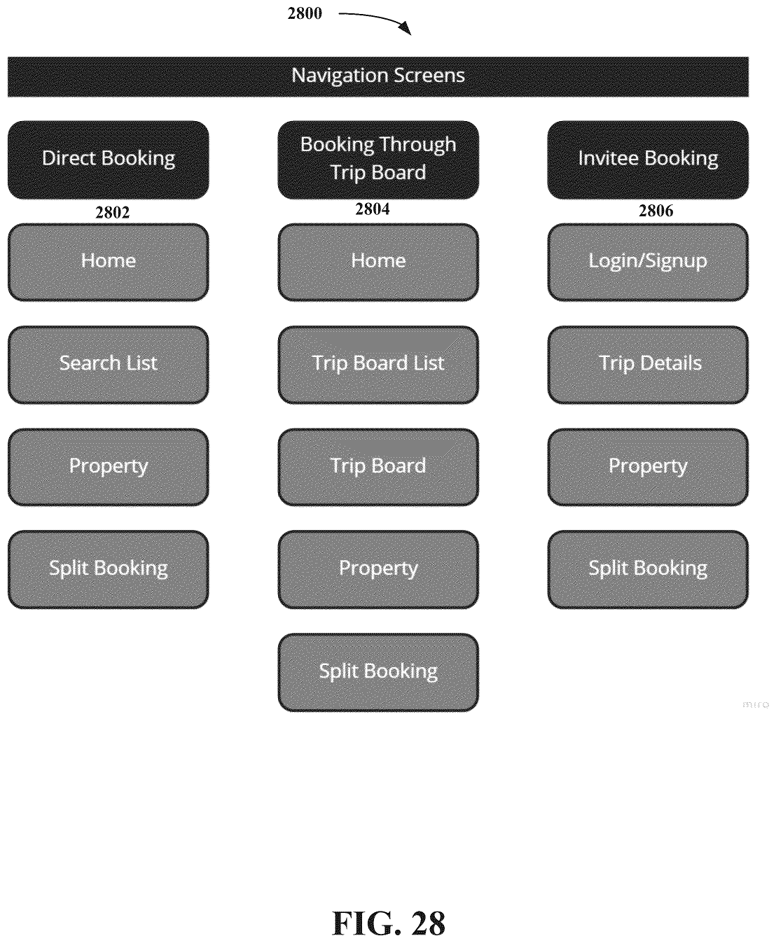

FIG. 28 is a diagram of an example of mobile application screen flows 2800 in accordance with the systems and methods described herein. Various mobile application screens may be used to implement the systems and methods described herein on a computing device, for example a mobile telephone handset or other computing device such as a computer, computing pad, or any other suitable computing device. The systems and methods described herein may, in one embodiment, include a series of navigation screens including direct booking 2802, booking through a trip board 2804, and invitee booking 2806. Each of these navigation screens may include a series of sub-screens or menus. For example, the direct booking screen 2802 may include a home sub-screen 2808, a search list sub-screen, a property sub-screen, and a split booking sub-screen (or corresponding menus). Fee booking through trip board screen may include a home sub-screen, a trip board list sub-screen, a trip board sub-screen, a property sub-screen, and a split booking sub-screen (or corresponding menus). The invitee booking screen may include a login or sign-up sub-screen, a trip details sub-screen, a property sub-screen, and a split booking sub-screen (or corresponding menus).

An example embodiment may create a space in the Whimstay travel website or application for users to create groups, add people to the groups, and interact, e.g., be able to communicate within the Whimstay travel website or application.

A traveler may try to decide where to go on a trip and coordinate where to go on a trip with my group of friends and/or family. However, it takes a long time to suggest properties, take everyone's votes and opinions into account and keep track of all the trip information when using conventional travel websites because conventional travel websites have no way to discuss properties. Accordingly, planning travel can be exhausting.

An example embodiment may provide travel website or travel application, e.g., Whimstay users, a way to case the process of trip planning by creating a TripChat to which the users may add properties and discuss the properties with people, e.g., family and/or friends, invite people to give votes, and allow for comments that may leading to booking a trip to one or more of the properties discussed. For example, in some example embodiments, such a system may provide a dedicated screen on the travel site to act as a group. Some example embodiments may provide for inviting people directly to join the TripChat and share properties within the TripChat. In some example embodiments, users may be able to “like” any property and up-vote a property. Users may comment on each property to share their concerns and views. Additionally, users may add any other property that the user might like to the TripChat. Additionally, users may observe the votes and make comments to decide on a particular trip and particular accommodations for the trip and other arrangements for the trip, e.g., rental car, flight, or other travel arrangements. Additionally, users may be able to communicate decisions and book the trip using a single click, e.g., one click per user to decide or vote, one additional click by the host to book (or in some examples, the host may abstain from voting). Additionally, in an example embodiment, many people may be able to help in the process of planning and booking through TripChat as a collaborative effort.

Accordingly, as discussed above, some example embodiments may allow for both the discussion of travel arrangements, e.g., in a travel chat, and split payment. Split payment user types may include an owner, e.g., a Whimstay account holder who initiates a TripChat and an invitee, e.g., a user who is invited by the owner to join a TripChat.

Generally, embodiments of the present disclosure include systems and methods for allowing for communications within a travel planning website or other computerized platform. The tools may allow users to schedule communications, discuss proposed travel, and book the proposed travel. In some examples, the tools may allow a group of users to split the billing of the travel being discussed. In other examples, the tools may allow a group of users to discuss a particular travel plan without split billing. For example, a family may discuss proposed travel even when one member of the family is going to pay for the travel.

A travel website may be used by a number of user types. These user types may include but are not limited to (1) solo travelers, (2) couple travelers, (3) family or a large group of family traveling together, (4) friends traveling together, or (5) other types of groups.

In some examples, scenarios for the travel website user types may include, but are not limited to scenario 1: a solo traveler wants to solicit opinions of friends or family to decide on a place to stay, scenario 2: a couple wants to travel to a place and needs to decide which place to stay, scenario 3: a group of friends wants to travel together and make a collaborative decision on which property to rent together, scenario 4: a small family or a large group of families wants to plan a vacation and have members of the family give their opinions and help them decide place to stay, to name a few example scenarios.

The example scenarios may be used to illustrate a number of example solutions for each scenario. For example, scenario 1 and scenario 2 may only require a minimum amount of coordination. Because only a minimum amount of coordination may be required for scenario 1 and scenario 2 (solo travelers and couple travelers), a TripChat feature may be used for recommending properties and communicating about each of the recommended properties, e.g., between the couple, or be friends or advisers of the solo traveler.

Scenario 3 and scenario 4 may include a larger group. Because scenario 3 and scenario 4 may include a larger group, these scenarios may be difficult and chaotic to coordinate. Accordingly, coordination of scenario 3 and scenario 4 may be difficult. Scenario 3 and scenario 4 may be coordinated using the TripChat feature as an efficient way to plan a trip. For example, in some embodiments, the TripChat feature may allow multiple people to share properties withing the group chat. In some embodiments, the TripChat feature may allow multiple people to share opinions on their selection or selections. Additionally, in some embodiments, the TripChat feature may allow multiple people to vote on their selection or selections.

In some embodiments, users may be able to join a TripChat. The TripChat may be a chat within the booking software. In some embodiments, the TripChat may allow a group to discuss properties that may be booked within the booking software. Users may be able to add properties to the TripChat for everyone within the group to view. In some embodiments, users may be able to like a property to upvote that property, e.g., within a ranking of properties being discussed by the group. In an example embodiment, users may be able to share opinions on each property that the group is discussing. In some embodiments, users may be able to reply to specific messages to create a thread of communication. In some embodiments users may have different jobs-pain-gain in the planning of a group trip process, as summarized in TABLE 1, below. For example, without a built-in chat, planning a trip may require a separate chat application, which is a hassle to access. In an example embodiment, a dedicated chat screen in the travel site or travel application may be provided. Sharing places may be a hassle in a separate chat as compared to using a chat within a travel site or travel application. Keeping track of opinions and voting may also be made easier when the chat used is a TripChat within the travel site or travel application. The TripChat may also provide for easier management of a proposed trip or shared management of a proposed trip.

A traveler may try to decide where to go on a trip. For example, a traveler may try to decide where to go on vacation. The traveler may want to coordinate that trip or vacation with the traveler's group of friends and family. However, it may take a long time to suggest properties, solicit everyone's votes and opinions and keep track of the trip details because the travel website has no way to discuss properties within the platform itself which is tiering to the traveler and may make the traveler feel exhausted. Accordingly, some aspects of the systems and methods described herein may provide the travel website users with a way to case the process of trip planning by creating a TripChat to which the users may add properties and discuss the properties. The TripChat may allow users to invite people to give votes and comments, e.g., on a particular trip or vacation. The users may also book the trip, e.g., based on voting results and what trips the users want to take.

Some embodiments may have various TripChat user types, such as an owner and an invited guest. An owner may be, for example, the travel website account holder who may create a TripChat from his or her own account. An invited guest or invitee may be a user who is invited by the owner to chat, e.g., about a trip or vacation that they are invited to attend.

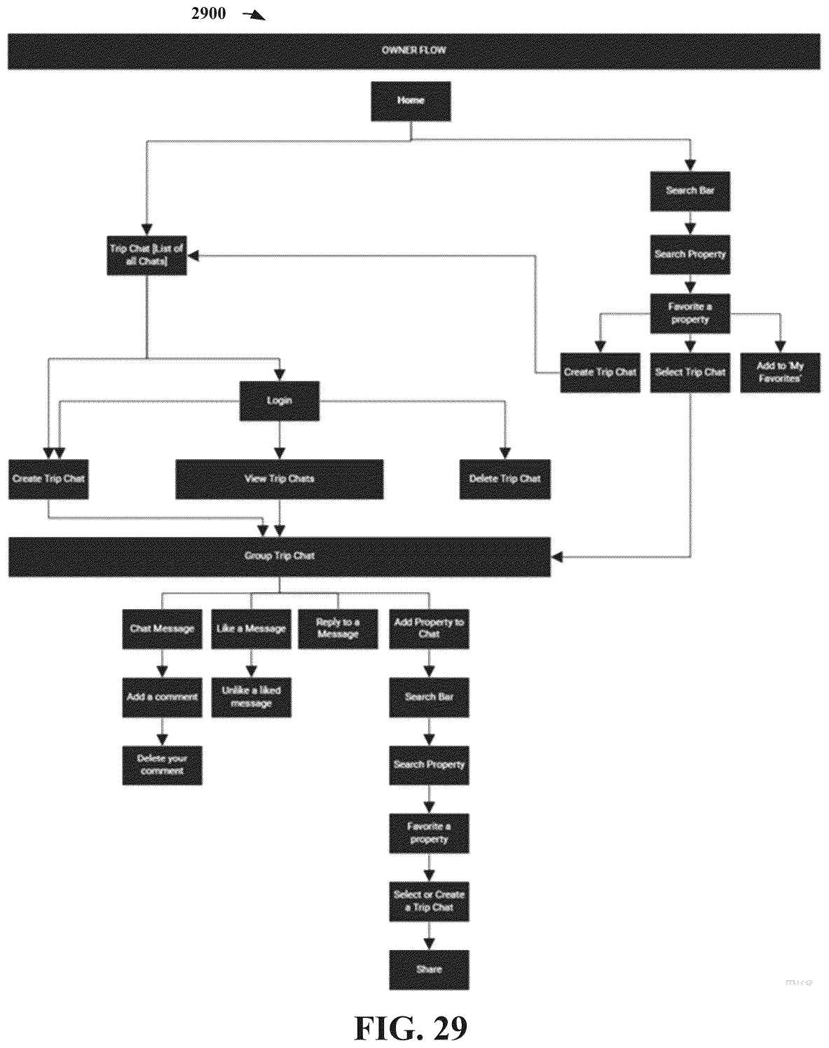

FIG. 29 is a flowchart of an example method 2900 for group communication in accordance with the systems and methods described herein. The illustrated example shows an owner flow. The owner flow may begin from a home location. From the home location the system may process a TripChat by presenting a list of all chats. From the list, a user may log into or create one or more chats. After login, the user may view existing TripChats or delete TripChats. From a created TripChat or from a list of TripChats one or more group TripChats may be entered. When a user is in a group TripChat they may send chat messages. The user may like messages. The user may also reply to a message or add a property to the chat. When a user sends a chat message, they may also add a comment on other messages or delete a comment on other messages. Users may also like or unlike messages. Additionally, when users add a property to a chat, they may do so by going to a search bar to search for a property to add to the TripChat. The user may also select a favorite property. The user may select or create a TripChat for the favorite property or for the property they find within the search. When a trip is created or selected the user may share the property within the TripChat. From home, the owner may proceed to a search bar to search for property. In some examples the user may also search for a favorite property.

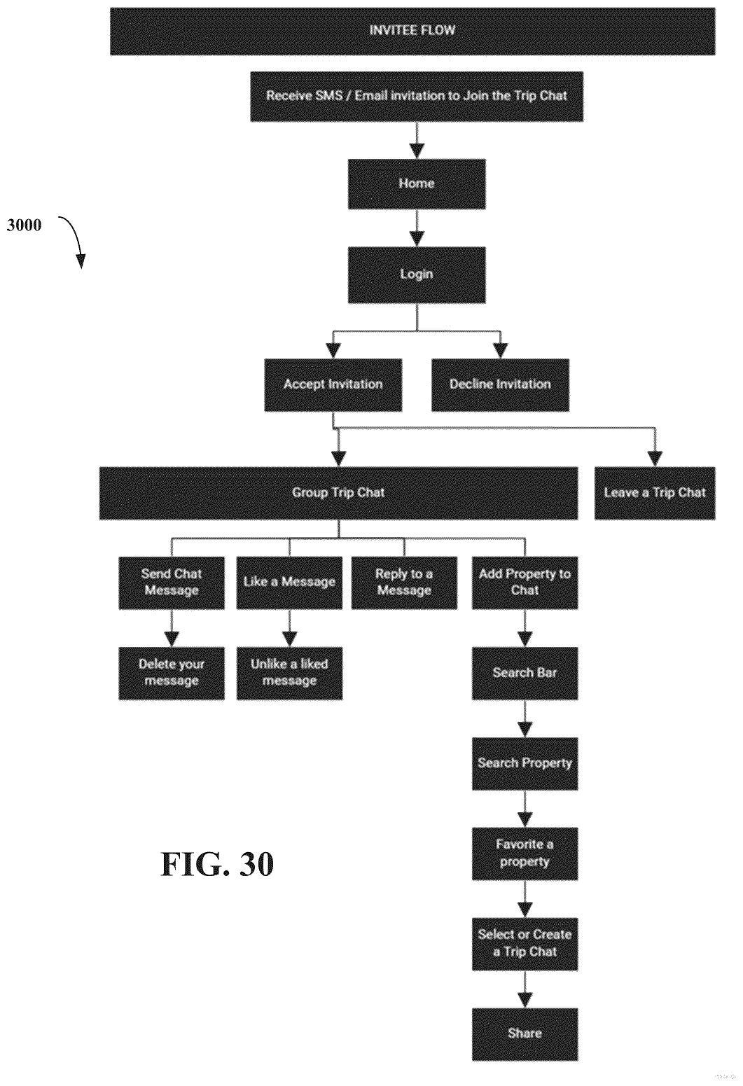

FIG. 30 is another flowchart of another example method 3000 for group communication in accordance with the systems and methods described herein. The invitee flow of the method 3000 may include receiving SMS or e-mail invitations to join the trip chat. Which may include logging in through a home screen to accept or decline the invitation. Within the invitation is accepted the user may then join the group trip chat or leave the trip chat. When the user joins the group trip chat they may send chat messages like a message, reply to a message. Additionally, when in a group trip chat a user may add property to the chat search properties using a search bar, a favorite property.

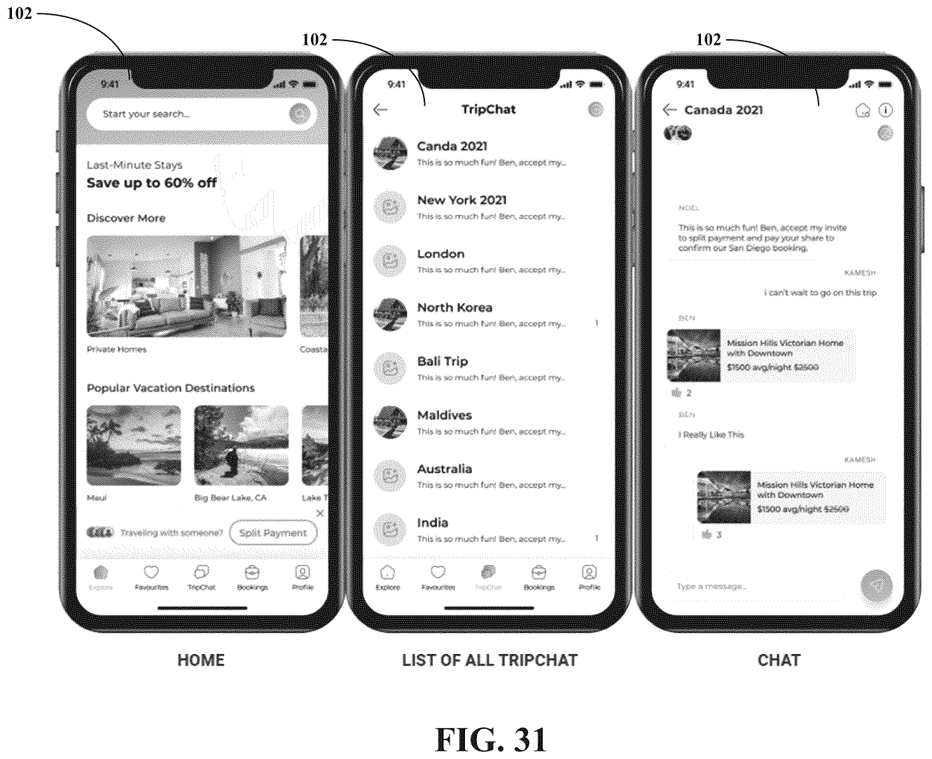

FIG. 31 is a series of diagrams of another example of mobile application screens 102 including a home screen, a list of TripChats, and an example chat in accordance with the systems and methods described herein. As illustrated in the figure, a home screen may include an area to start a search, last minute savings on stays, as well as screens for popular destinations and further discovery of other possible trips. The home screen may also include options to split payments as well as explore functionality, favorites, TripChat functionality, bookings, and access to the user's profile. The TripChats functionality may include a screen for chats related to one or more possible trip locations. For example, in the illustrated example, TripChats for Canada, New York, London, North Korea, Bali, Maldives, Australia, and India are illustrated. an example screen from the Canada trip entitled “Canada 2021” is illustrated as one possible chat. The TripChat may allow for different possible accommodations to be discussed and sent within the chat. For example, “Mission Hills Victorian Home” is shown in the example. Voting or comments may also be allowed related to the properties or related to the overall trip.

Coupling a chat feature to a travel website, travel application, or travel app, e.g., on a mobile telephone handset, or other electronic device, may provide functionality not currently available within standalone chat services or travel websites. For example, the combination of the chat feature and the travel website, travel application, or travel app may allow users to present travel options more quickly and easily then when sending such options in a standalone chat. In a standalone chat a user will need to copy and paste web information for a hotel accommodation to be discussed in the chat, for example. By integrating the chat and the travel site, travel application, or travel app, users may be able to use various features that are not available without an integrated system. For example, within a chat integrated with the travel functionality users may be able to share hotel information, rental car information, or other travel information without cutting and pasting. For example, in some embodiments, the information may be shared with a single click or a low number of clicks. Furthermore, in some embodiments, members of the chat may automatically be added to the travel itinerary for booking purposes. It may also be possible to add additional people to the trip who are not in the chat. For example, young children might not be in the chat, but might still travel on a family trip.

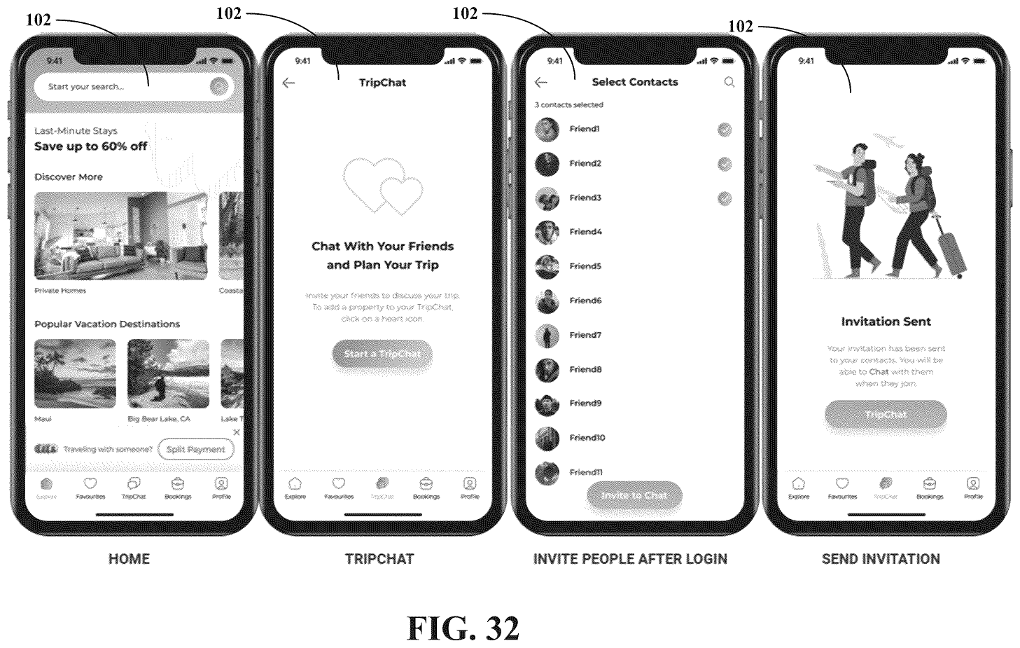

FIG. 32 is a series of diagrams of another example of mobile application screens 102 including a home screen, a TripChat start screen, a list of people to potentially chat with in the TripChat, and a TripChat invitation screen in accordance with the systems and methods described herein. Some aspects of FIG. 32 are the same or similar to FIG. 31. A TripChat may be started from a screen on a mobile telephone handset. The screen may allow a user to start a trip chat. The beginning of a trip chat may include inviting people to the chat after the user logs in to a travel website or travel application account. In the illustrated example, people to invite may be selected from a list, e.g., such as a list of the user's friends and family. The systems and methods described herein may indicate that invitations to the trip chat have been sent after the user invites one or more people to the chat.

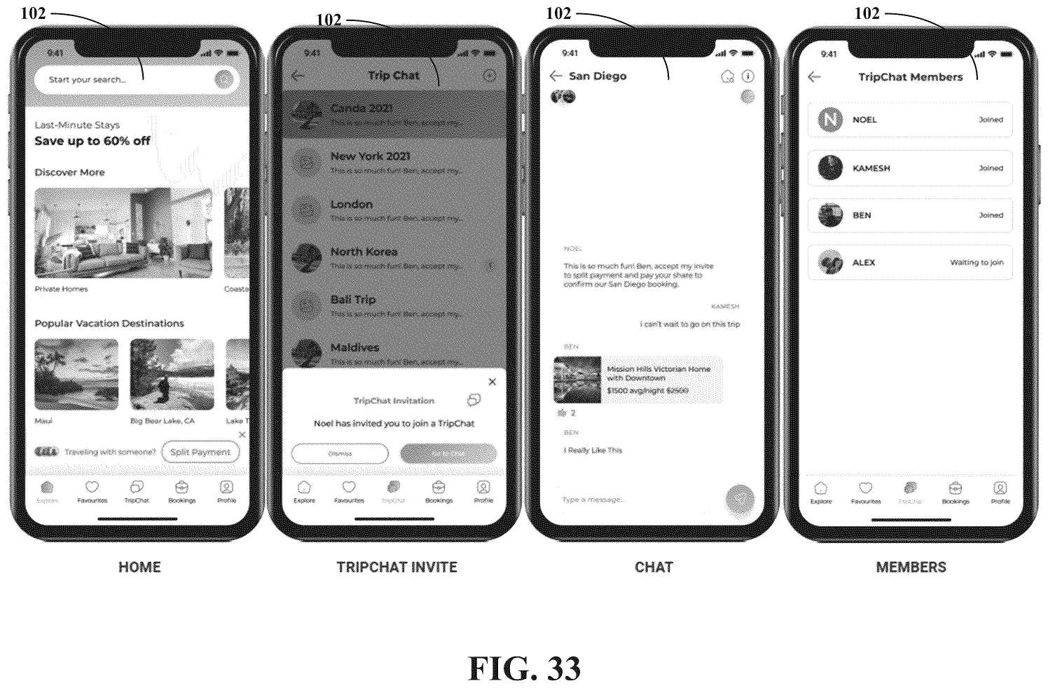

FIG. 33 is a series of diagrams of another example of mobile application screens 102 including a home screen, a TripChat invite screen, an example chat within the TripChat, and a list of members of a TripChat in accordance with the systems and methods described herein. In the example of FIG. 33, a TripChat invitation may be initiated from a TripChat invitation menu. The user may select which TripChat to enter and send invitations. For example, the menu may be used in conjunction with a previously started TripChat. In the illustrated example, members of the chat may discuss the trip and provide suggestions about possible accommodations. The suggestions may include pricing information. Additionally, the members of the chat may provide comments. In another example screen a list of TripChat members, e.g., the people taking part in the TripChat, may also be provided on one of the screens of the travel website or travel application.

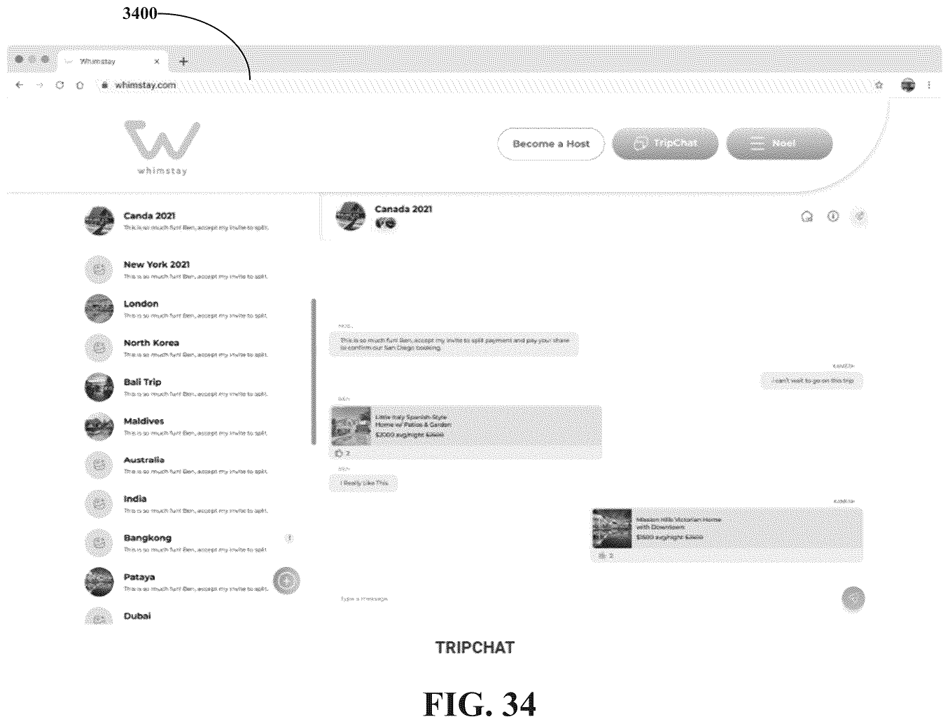

FIG. 34 is a diagram illustrating an example TripChat website 3400 in accordance with the systems and methods described herein. The example in the figure may provide more information on a single screen of the website as compared to a screen in an application running on a mobile telephone handset. For example, the website may be on a much larger screen than the screen of the mobile telephone handset used for the mobile telephone handset application. Accordingly, the website may include a list of possible chats on the same screen as a selected chat. For example, in the illustrated example, a list including “Canada 2021” is included on the left-hand side of the window and the chat for “Canada 2021” is included on the right side of the window and is the selected TripChat. Additionally, various control buttons such as “Become a Host,” “TripChat,” and “Noel” are provided. The “Become a Host” button may allow a user to become the host of the TripChat. Note that the “Become a Host”. The “trip chat” button may allow a user to start a new TripChat. The name button, e.g., “Noel” may be the use the name of the user of that particular web browser on that particular computer and may allow that user access to a menu of features.

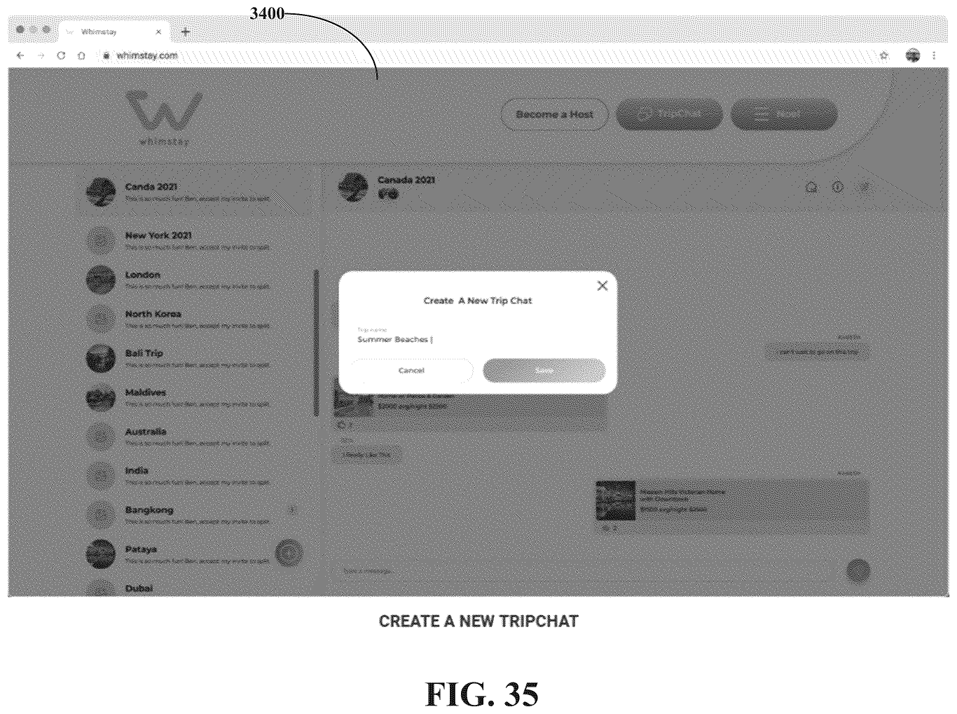

FIG. 35 is a diagram illustrating an example TripChat website 3400 including creating a new TripChat in accordance with the systems and methods described herein. FIG. 7 is generally similar to FIG. 34. However, FIG. 35 includes a “create a new TripChat” button. The “create a new TripChat” button may allow a user to create a new chat for a given trip.

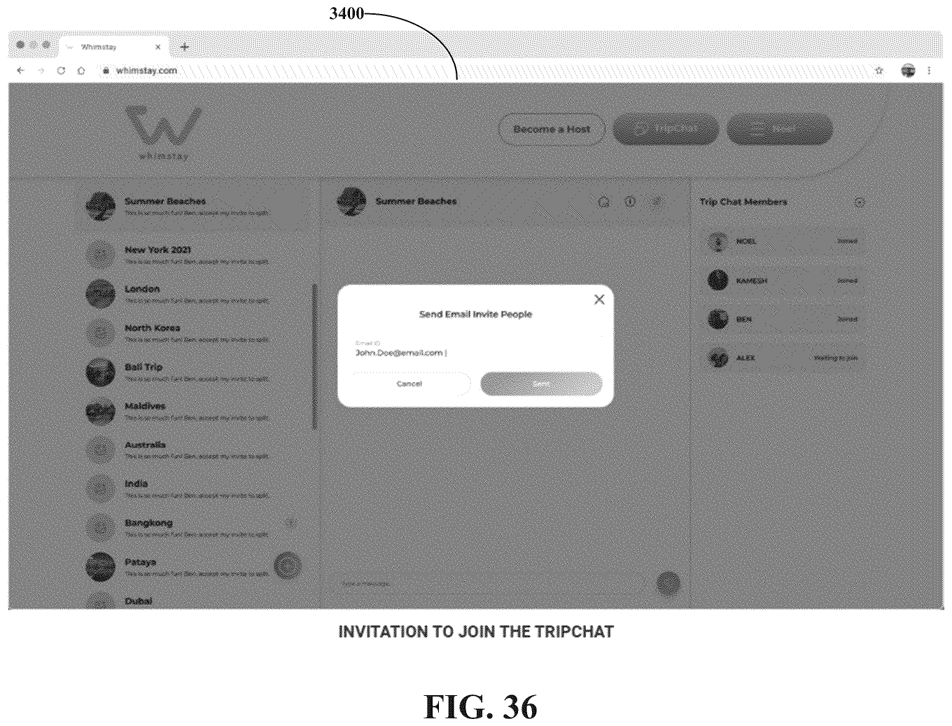

FIG. 36 is a diagram illustrating an example TripChat website 3400 including an invitation to a TripChat in accordance with the systems and methods described herein. FIG. 8 is generally similar to FIGS. 34 and 35. However, FIG. 36 includes a “send email invite people” button. The “send email invite people” button may allow a user to invite people to the chat.

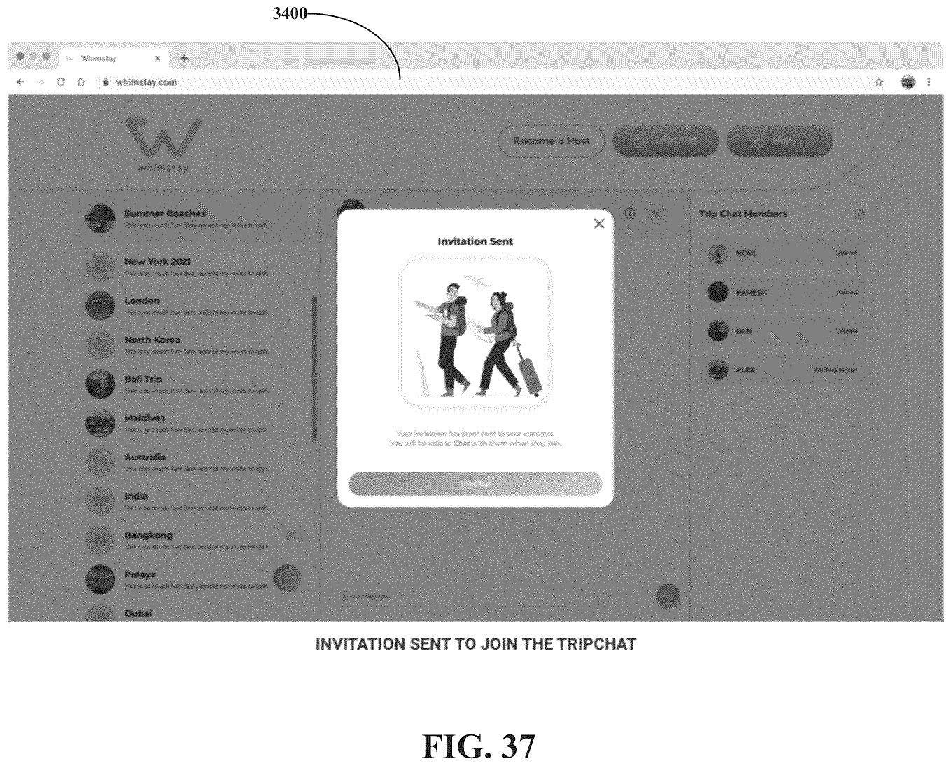

FIG. 37 is a diagram illustrating an example TripChat website 3400 including an indication that an invitation to a TripChat has been sent in accordance with the systems and methods described herein. As illustrated, after an invitation is sent to join a TripChat, a message may indicate that the invitation has been sent to confirm this to the user.

In an aspect, a method of split rental of a property may include one or more of identifying a suitable property, determining that the property is suitable for more than one person, transferring to split booking based on the determination, receiving input of a number of split-bookers, receiving input on how to split fees, transmitting notification to the split-bookers, receiving agreement to split-book from a split-booker, selecting a sharing amount based on the received agreement, determining when the total fee is covered, when the total fee is covered, determining that the booking is still available, and completing booking based on the determination that the booking is still available.

In an aspect, identifying a suitable property includes presenting one or more properties to at least one user for selection by the user.

In an aspect, determining that the property is suitable for more than one person includes determining at least one of a size of the property, a number of bedrooms of the property, and a size of a bedroom of the property and comparing the at least one of a size of the property, a number of bedrooms of the property, and a size of a bedroom of the property to a predetermined threshold.

In an aspect, receiving input of the number of split-bookers comprises an input from a user.

In an aspect, receiving input of the number of split-bookers comprises a representative of each user splitting the booking.

In an aspect, determining when the total fee is covered comprises receiving a number of split-bookers, receiving a payment amount for each of the number of split-bookers, and determining when the total fee is covered based on the number of split-bookers and the payment amount for each of the number of split-bookers.

In an aspect, the method may include determining that the booking is still available includes checking a database of bookings and determining from data in the database when the booking is still available.

In an aspect, a system for split rental of a property may include a processor and a memory soring instructions that when executed cause the processor to identify a suitable property, determine that the property is suitable for more than one person, transfer to split booking based on the determination, receive input of a number of split-bookers, receive input on how to split fees, transmit notification to the split-bookers, receive agreement to split-book from a split-booker, select a sharing amount based on the received agreement, determine when the total fee is covered, when the total fee is covered, determine that the booking is still available; and complete booking based on the determination that the booking is still available.

In an aspect, a method of a vacation rental property may include presenting a selected travel destination within a TripChat of a travel site, allowing for communications to plan a trip to the selected travel destination within the TripChat of the travel site, storing one or more opinions on the selected travel destination within the TripChat of the travel site, and tracking a vote on the selected travel destination within the TripChat of the travel site.

In an aspect, the method may include booking the selected travel destination within the travel site.

In an aspect, the method may include splitting the cost of booking the selected travel destination within the travel site.

It should also be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

To the extent the embodiments disclosed herein include or operate in association with memory, storage, and/or computer-readable media, then that memory, storage, and/or computer-readable media are non-transitory. Accordingly, to the extent that memory, storage, and/or computer-readable media are covered by one or more claims, then that memory, storage, and/or computer-readable media is only non-transitory.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

It is to be understood that this disclosure is not limited to the particular embodiments described herein, as such may, of course, vary. It is also to be understood that the terminology used herein is for the purpose of describing particular embodiments only and is not intended to be limiting.

Various aspects have been presented in terms of systems that may include several components, modules, and the like. It is to be understood and appreciated that the various systems may include additional components, modules, etc. and/or may not include all the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Operational aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a Compact Disk Read Only Memory (CD-ROM), or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

Furthermore, the one or more versions may be implemented as a method, apparatus, or article of manufacture using standard programming and/or engineering techniques to produce software, firmware, hardware, or any combination thereof to control a computer to implement the disclosed aspects. A non-transitory computer-readable medium may include any non-transitory computer-readable media, such as, but are not limited to magnetic storage devices (e.g., hard disk, floppy disk, magnetic strips . . . ), optical disks (e.g., compact disk (CD), digital versatile disk (DVD), BluRay™ . . . ), smart cards, solid-state devices (SSDs), and flash memory devices (e.g., card, stick). Of course, those skilled in the art will recognize many modifications may be made to this configuration without departing from the scope of the disclosed aspects.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the figures may be configured to perform one or more of the methods, features, or steps described in the figures. The algorithms described herein may also be efficiently implemented in software and/or embedded in hardware.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description are presented in terms of algorithms and symbolic representations of operations on data bits within a computer memory. These algorithmic descriptions and representations are the methods used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following disclosure, it is appreciated that throughout the disclosure terms such as “processing,” “computing,” “calculating,” “determining,” “displaying” or the like, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. It will be appreciated that a variety of programming languages may be used to implement the teachings of the invention as described herein.

The figures and the following description describe certain embodiments by way of illustration only. One skilled in the art will readily recognize from the following description that alternative embodiments of the structures and methods illustrated herein may be employed without departing from the principles described herein. Reference will now be made in detail to several embodiments, examples of which are illustrated in the accompanying figures. It is noted that wherever practicable similar or like reference numbers may be used in the figures to indicate similar or like functionality.

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats.

Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming.

Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of split rental of a property, the method comprising:
identifying a suitable property;
determining that the property is suitable for more than one person;
transferring to split booking based on the determination;
receiving input of a number of split-bookers;
receiving input on how to split fees;
transmitting notification to the split-bookers;
receiving agreement to split-book from a split-booker;
selecting a sharing amount based on the received agreement;
determining when the total fee is covered;
when the total fee is covered, determining that the booking is still available; and
completing booking based on the determination that the booking is still available.

2. The method of claim 1, wherein identifying a suitable property includes presenting one or more properties to at least one user for selection by the user.

3. The method of claim 1, wherein determining that the property is suitable for more than one person includes determining at least one of a size of the property, a number of bedrooms of the property, and a size of a bedroom of the property and comparing the at least one of a size of the property, a number of bedrooms of the property, and a size of a bedroom of the property to a predetermined threshold.

4. The method of claim 1, wherein receiving input of the number of split-bookers comprises an input from a user.

5. The method of claim 1, wherein receiving input of the number of split-bookers comprises a representative of each user splitting the booking.

6. The method of claim 1, wherein determining when the total fee is covered comprises receiving a number of split-bookers, receiving a payment amount for each of the number of split-bookers, and determining when the total fee is covered based on the number of split-bookers and the payment amount for each of the number of split-bookers.

7. The method of claim 1, wherein determining that the booking is still available includes checking a database of bookings and determining from data in the database when the booking is still available.

8. A system for split rental of a property, the system comprising:
a processor; and
a memory soring instructions that when executed cause the processor to:
identify a suitable property;
determine that the property is suitable for more than one person;
transfer to split booking based on the determination;
receive input of a number of split-bookers;
receive input on how to split fees;
transmit notification to the split-bookers;
receive agreement to split-book from a split-booker;
select a sharing amount based on the received agreement;
determine when the total fee is covered;
when the total fee is covered, determine that the booking is still available; and
complete booking based on the determination that the booking is still available.

9. The system of claim 8, wherein identifying a suitable property includes presenting one or more properties to at least one user for selection by the user.

10. The system of claim 8, wherein determining that the property is suitable for more than one person includes determining at least one of a size of the property, a number of bedrooms of the property, and a size of a bedroom of the property and comparing the at least one of a size of the property, a number of bedrooms of the property, and a size of a bedroom of the property to a predetermined threshold.

11. The system of claim 8, wherein receiving input of the number of split-bookers comprises an input from a user.

12. The system of claim 8, wherein receiving input of the number of split-bookers comprises a representative of each user splitting the booking.

13. The system of claim 8, wherein determining when the total fee is covered comprises receiving a number of split-bookers, receiving a payment amount for each of the number of split-bookers, and determining when the total fee is covered based on the number of split-bookers and the payment amount for each of the number of split-bookers.

14. The system of claim 8, wherein determining that the booking is still available includes checking a database of bookings and determining from data in the database when the booking is still available.

15. A method of a vacation rental property, the method comprising:
presenting a selected travel destination within a TripChat of a travel site;
allowing for communications to plan a trip to the selected travel destination within the TripChat of the travel site;
storing one or more opinions on the selected travel destination within the TripChat of the travel site; and
tracking a vote on the selected travel destination within the TripChat of the travel site.

16. The method of claim 15, further comprising booking the selected travel destination within the travel site.

17. The method of claim 16, further comprising splitting the cost of booking the selected travel destination within the travel site.
